(19) United States
(12) Patent Application Publication
(10) Pub. No.: US 2008/0059492 A1
(43) Pub. Date: Mar. 6, 2008

(54) Systems, methods, and storage structures for cached databases

(76) Inventor: Stephen A. Tarin, Menlo Park, CA (US)

Correspondence Address: JONES DAY, 222 EAST 41ST ST, NEW YORK, NY, 10017, US

(21) Appl. No.: 11/514,724

(22) Filed: Aug. 31, 2006

(51) Int. Cl. G06F 7/00

(52) U.S. Cl. 707/100

(57) ABSTRACT

Systems and methods for clustered access to as many columns as possible given a particular ongoing query mix and a constrained amount of disk space is disclosed. A compressed database is split into group of columns, each column having duplicates removed and being sorted. Then certain groups are transferred to a fast memory depending on the record of previously received queries.

### FIELD OF THE INVENTION

The present invention relates to storage structures for databases, and in particular to structures that cache selected storage structures in order to improve response times with limited storage resources. The invention also includes systems and methods utilizing such storage structures.

### BACKGROUND OF THE INVENTION

Serial storage media, such as disk storage, may be characterized by the average seek time, that is how long it takes to set up or position the medium so that I/O can begin, and by the average channel throughput (or streaming rate), that is the rate at which data can be streamed after I/O has begun. For a modern RAID configuration of 5-10 disks, seek times are approximately 8 msec. and channel throughputs are approximately 130 MB/sec. Consequently approximately 1 MB of data may be transferred from the RAID configuration in the time required to perform one (random) seek (referred to herein as the “seek-equivalent block size”). For a single-disk channel, the substantially lower throughput with an approximately equal seek time leads to a substantially lower seek-equivalent block size. If the storage structures are arranged on disk so that after each seek the average amount of data transferred is much larger than the seek-equivalent block size, then the time spent seeking is relatively less of a performance penalty. In other words, it is preferable that the stream-to-seek ratio, defined herein as the ratio of the average amount of data transferred after each seek to the seek-equivalent block size, be large. For example, if approximately 5 MB is transferred after each seek in a typical RAID configuration with a seek-equivalent block size of 1 MB, the stream-to-seek ratio is 5.

In addition to the above characterization, there are several trends that have emerged for hard disks over a number of years of development. One is that the seek-equivalent block size has been roughly constant, approximately 1 MB for several years. The second is that disk storage capacity has followed much closer to Moore's law than has the streaming rate. That is, the increase in streaming rate is much slower than the increase in storage density. This has been mitigated somewhat by faster disk speeds, but the overall trend is that the time it takes to totally drain a hard drive is increasing as approximately the square root of Moore's law (abbreviated Moore/2, here, since Moore's law is generally plotted on a log/linear graph).

These trends have consequences for database design. One implication is that eventually database systems will more likely be IO bound. Another implication is that for fixed query response times, the accessible fraction of a disk for answering a given query is decreasing at Moore/2. This implies that, unless the disk space can be put to use creatively, the average dead space on the disk will increase at Moore/2 (or the average turnaround time for a query will increase—albeit with gains in the amount of data queried). Designers have tried to circumvent this Moore/2 dependence by using ever-increasing numbers of disks (i.e. more than 1000 in some of today's benchmarks), so that the overall throughput of the disk system can keep up with Moore's law. This is presumably only a stopgap solution.

Another consequence of the dependence on Moore/2 is that memory, which is increasing at Moore, is growing at Moore/2 relative to the rate at which a disk may be completely read, while at the same time the number of seek-equivalent blocks that can be fit in memory is increasing at Moore. Because of this, main memory database structures will become increasingly valuable to performance because more of the database will fit in main memory relative to the fractional amount that can be streamed from disk. Another consequence is that the balance of the CPU time to disk IO time for a given query is shifting so that more CPU time is available and may be used, for example, for more complex encoding or compression of values in the database.

Another approach to overcoming these trends in disk technology is data redundancy, storing redundant copies of the data or indices arranged for a variety of efficient access by. For example, V. Y. Lum [Communications of the ACM, 13, 11, (November 1970), pp. 660-665] has described a redundancy arrangement for a table T having N attributes that results in minimum amount of disk I/O for a (conjunctive) query on a specified subset of k of those attributes. His method of overcoming the serial nature of the medium is to attempt to store indexes (actually inverted lists) mapping to each of the 2^{k} conjunctive queries that might be asked. He suggests that

$$( \begin{matrix}N \\ k\end{matrix} )$$

differently sorted but otherwise duplicate indexes on T be stored. Then a query on, for example, columns A₃, A₄, and A₉ would access one of the indexes with these three attributes forming the first part of the composite sort order for T, thereby minimizing the number of IOs. As an example, suppose N=10 and k=3. Then

$$( \begin{matrix}10 \\ 3\end{matrix} ) = \frac{10 \times 9 \times 8}{3 \times 2 \times 1} = 120$$

copies of the index must be stored for Lum redundancy. Lum presented an example with 4 columns, which leads to a six-fold redundancy since the maximum 4-pick-k is

$$( \begin{matrix}4 \\ 2\end{matrix} ) = 6.$$

Others have suggested that such combinatorial index and data redundancy is not practical. For example, Gray and Reuter [Transaction Processing: Concepts and Techniques. Morgan Kaufmann Publishers, 1993, p. 893] discuss this issue, stating “Maintaining separate [B-tree indexes] for all types of attribute combinations in all permutations solves some of the retrieval problems, but it adds unacceptable costs to the update operations. Considering the arguments already given, it is obvious that for n attributes, virtually all n! attribute concatenations would have to be turned into a B-tree in order to get symmetric behavior with respect to range queries on arbitrary subsets; this is certainly not a reasonable scheme.”

Recently, optimized partial redundancy has been suggested, for example, storage of those views and indices that a model of the database indicates as most useful in promoting query efficiency. Novel algorithms have been suggested for selecting which views and indices to store redundantly. See, e.g. [Ladjel Bellatreche, Kamalakar Karlapalem, Michel Schneider Proceedings of the ninth international conference on Information knowledge management CIKM 2000, November 2000], or [Jian Yang, Kamalakar Karlapalem, Qing Li, Proceedings of the International Conference on Very Large Databases, August 1997, pp. 136-145], or [Y. Kotidis, N. Roussopoulos. ACM Transactions on Database System, December 2001.].

However, storing these redundant differently-sorted indices, with or without materialized views, at best only partly minimizes disk IO because such indices are an efficient means for fetching only pointers to the actual records (also known as “record identifiers”) accession numbers. Completion of nearly all queries requires actually fetching identified records from the base tables. For result sets having greater than approximately 1% of the records in a base table that is not clustered according to the index used for access, this almost always entails a complete scan of the disk blocks holding the base table, leading to substantial IO costs. Thus, schemes that store only redundant indices do not necessarily minimize total disk IO.

Of course, if the base table is clustered in the index order, then the disk IO is limited to the actual result set. But only very rarely will a database administrator store even two or three different orderings of the base table, because of the large space penalty. Another method of minimizing disk IO is to store complete records within the indexes, so that once the section of the appropriate index is identified, only the records that satisfy the various filter criteria are read. However, this uses as much or more space than storing the different orderings of the base tables.

For a large class of problems, however, the cost of this level of data redundancy is prohibitive. For example, since many queries are never asked, storing the full set of embedded sorts (increasing as the factorial of the number of columns) of complete records would seldom be necessary. However, what is redundantly stored to just those tables required by the queries that are asked only reduces the number of stored tables by an arithmetic factor, without substantially mitigating the original combinatorial storage requirement.

Further, the cost of extra data redundancy should be balanced against its marginal return in query performance, which depends heavily on the actual query stream. For example, since many observed query streams have queries with at least one substantially restrictive condition filtering at least one column, adequate return is achieved once copies of the base tables each sorted on the columns appearing in the restrictive filtering conditions are stored. This is easily seen for the case where the restrictive filter conditions restrict the resulting records to those contained with a single seek block size. Then the cost of the seek to that block begins to dominate query cost so that restriction on further columns would not further decrease IO. Even with less-restrictive queries, the cost of storing even sort of two columns for more than a few columns would be prohibitive and lead to little return. Even a conjunctive query may now be efficiently performed by selecting the copy of that is sorted on the single attribute corresponding to the most restrictive filter condition, reading the few seek block that contain the correct records, and testing the other filtered attributes during this read. Thus, storing copies with all sort orders cause greatly increasing disk-space cost with diminishing returns on query speed.

In view of the above, it is a goal of this invention to develop data structures, and accompanying methods and systems using these data structures, that take cost-effective advantage of the above trends in disk technology to improve query performance.

Citation or identification of any reference in this Section or any section of this application shall not be construed that such reference is available as prior art to the present invention.

### SUMMARY OF THE INVENTION

One object of the data structures, methods, and systems of the present invention: the disk (or other serial media) will behave like a random access medium if the data access patterns can be arranged so that the stream-to-seek ratio is high. Of equal concern is that this data be substantially useful, rather than only sparsely populated with items of interest to actual queries.

It is a further object of this invention to provide for functionality that is equivalent or nearly so to that provided by storing the combinatorial multitude of the columns described above, without incurring the tremendous overhead of data-storage that would be required by simply duplicating the original base tables in the many sort orders. Restated, this goal is to provide a set of data structures that enable clustered access to as many columns as possible given a particular ongoing query mix and a constrained amount of disk space.

Clustered access effects a decrease in the number of seeks and/or the amount of data transferred during the processing of the queries. Thus reading a certain amount of useful data from a clustered table will generally take only a fraction as long as reading the same useful data from an unclustered table. Clustered access is taken herein to mean generally that records of interest (for example, to a query) are located close to each other on the storage medium. An example of clustered access is where records are stored sequential disk blocks so that the records in a prior block are earlier in the sort order than the records in a subsequent block (the records within a block not necessarily being in the sort order) and where the disk blocks reside contiguously (or in the same vicinity) on the disk medium.

The data structures and access methods in the current patent application are particularly suited for the above-described trends in disk hardware, although by no means specifically limited to such trends, or even to disks. They provide for dramatically more efficient use of the data streaming bandwidth, and simultaneously make use of the “dead space” described above by introducing optimal elements of controlled redundancy.

The above discussion can be crudely summarized as follows: The advantage of using data structures suited to serial media is that tremendously larger amounts of data can be stored on said media compared to random access memory (RAM). This invention takes advantage by introducing data stores that, while technically redundant, enable a disk-resident database to achieve performance levels equivalent to those in a main-memory database.

In a first embodiment the present invention statically stores a complete, or nearly complete, sorted set of compressed tables. To achieve this, the present invention compresses a database to a fraction of its original size. This can be accomplished with known techniques described, such as described in U.S. Pat. No. 6,009,432, or further techniques described herein. One method of compressing the various tabular structures is to replace individual values with tokens. In general, tables represented in this way may occupy as little as 10% or less of their original space. Thus, in the storage equivalent to a prior-art database table together with an index for each of its columns, approximately 25 compressed copies of the table can be realized. A table having 5 columns could be completely stored in each of 5 different sort orders in the same space a prior-art database would use, thus enabling not only fully indexed performance, but also fully clustered access on any or all of the attributes. This is in contrast to the prior-art database system that, for the same footprint, achieved fully indexed performance but clustered access on at most only one of the attributes.

In a second embodiment, the present invention manages a cache storing column-base partitions of the parent database arranged for clustered access. A reservoir of disk space is managed as a cache. The contents of this cache are table fragments and permutation lists, partitioned vertically as well as horizontally. (A table fragment may consist of one or more columns.) Data structures have a lifetime in cache determined by one of the usual caching algorithms, such as LRU (least recently used) or LFU (least frequently used), or by a more complex criterion that is novel to this invention. Once they migrate out of cache, they are lost, and must be regenerated. Generation can take place using permutation lists, if available, or by actually performing a sort of some other table fragment to generate the appropriate ordering of the relevant table fragments.

Ideally, permutation lists have a long lifetime in the cache, so that when a given column or table fragment is needed in a particular order, its generation can take place in linear time—that is, O(n), where n is the number of record fragments in that table fragment—because the desired permutation already exists.

In one embodiment of this database, data is stored generally columnwise, i.e. in separate files for each column or few columns. All columns from a given table will be stored in some form at least once, but some columns will be stored multiple times, in different sort orders. These sort orders will make it possible for efficient retrieval from disk (because it will be sequential, or possibly skip sequential) of a column's data that meets criteria on the values in the column that had directed the sorting. Only columns that needed to have their values returned (projected) or evaluated during common types of queries would need to be redundantly present, and only in sorting directed by columns that the criteria of these queries included. Thus such a database would have vertically partitioned, partially redundant, multiply sorted data. There is variable redundancy due to the variable numbers of columns of a given table with a given sorting, as well as the variable number of sortings for a column of a given table.

The above structures yield improved read performance over a range of queries, with the ability to minimize the total space by allowing analysis of the query stream, or of the time and frequency of the use of the various structures chosen by the optimizer, to determine which structures are generated and maintained over time. For instance, most queries may involve only certain projection columns, and some columns may be most important for criteria evaluation when projecting certain other columns. Thus certain sets of columns, sorted by relatively few other columns, may produce the most useful structures.

A further embodiment is suitable for a query stream that usually does not involve all of the data but instead is most commonly limited to a certain range in a given attribute or combination of attributes. Say a given time range (the last 2 quarters, out of the last 3 years, for instance), or geographic range (New York, out of the whole country), or even a set of products (the top 100, in terms of sales), makes up a moderate fraction of the database, but simultaneously makes up a sizable fraction of query requests. This fraction of the database, basically a vertical and horizontal partition of the data, can be redundantly sorted by more columns, and include more sort-ordered columns of data, yet still take up a manageable amount of disk space. Thus, performance of the most common types of queries, over the most commonly queried range of data, will be improved the most due to the increased likelihood that the highest performance data structures are present.

Citation or identification of any reference in this Section or any section of this application shall not be construed that such reference is available as prior art to the present invention.

### BRIEF DESCRIPTION OF THE FIGURES

The present invention may be understood more fully by reference to the following detailed description of the preferred embodiment of the present invention, illustrative examples of specific embodiments of the invention and the appended figures in which:

FIGS. 1A-B illustrate an exemplary database used to assist (but not limit) the description of the present invention;

FIG. 1C-D illustrate an exemplary value list and matrix representation of the exemplary database of FIGS. 1A-B;

FIG. 1E-H illustrate exemplary partitions and permutations of the exemplary database of FIGS. 1A-B;

FIG. 2 illustrates a method for constructing inter-table permutation lists;

FIGS. 3A-B illustrate exemplary displacement lists constructed for a selected partition of the exemplary database of FIGS. 1A-B;

FIGS. 4A-B illustrate exemplary cache contents;

FIG. 5 illustrates an embodiment of this invention's cache acting as a subsystem of a database management system;

FIG. 6 illustrates the effect of column sorting on data clustering;

FIG. 7 illustrates a table with information in each cell used for evaluating an instantaneous utility function of the associated column set for the current mix of queries; and

FIGS. 8A-B illustrate storage methods with use of one and several machines respectively; and

FIG. 8C illustrate an exemplary organization of a machine suitable for performing storage methods described in this disclosure;

FIG. 9 illustrates permutation lists; and

FIG. 10 illustrates an exemplary table converted into a RID matrix format.

### DETAILED DESCRIPTION OF THE PREFERRED EMBODIMENTS

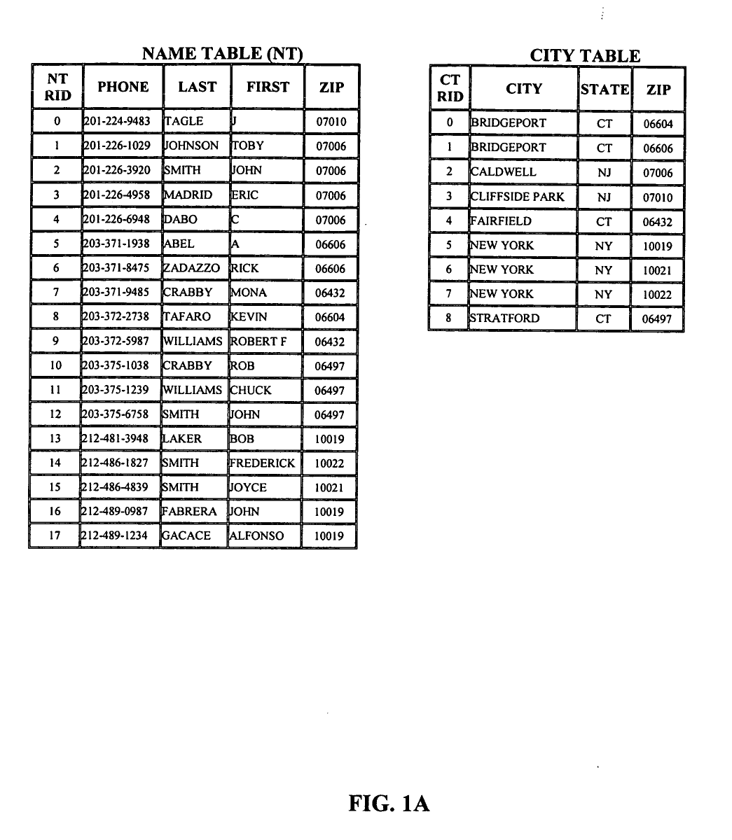

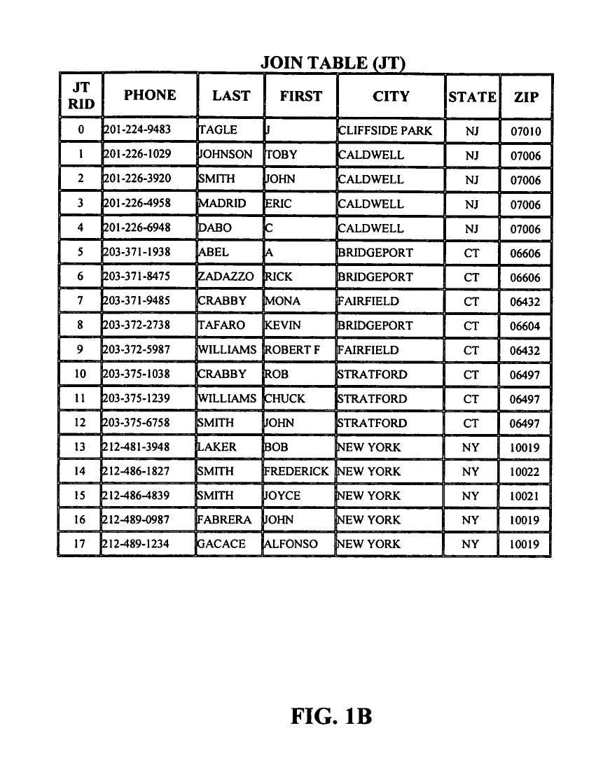

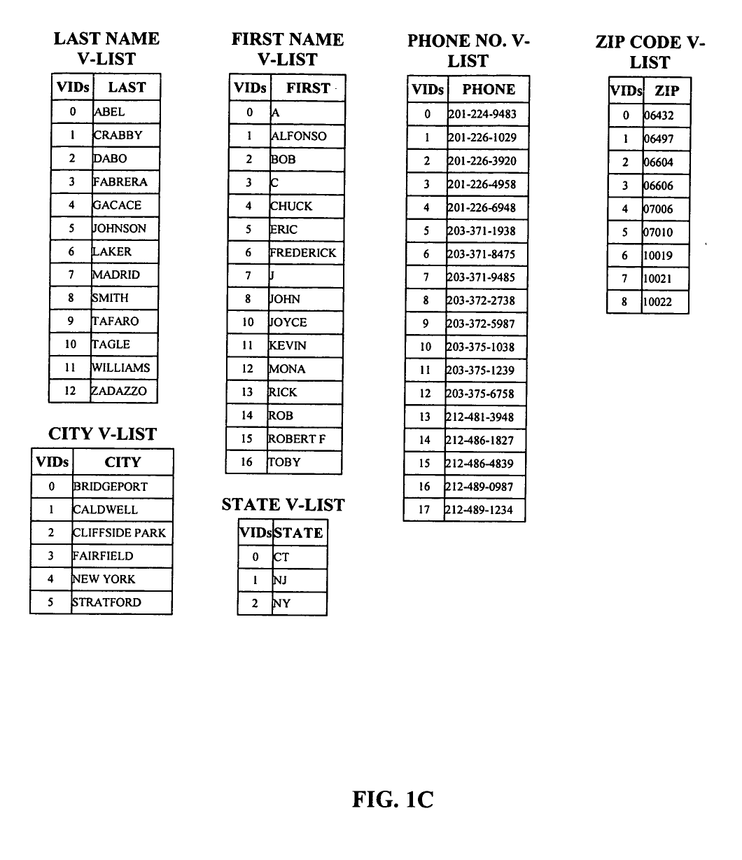

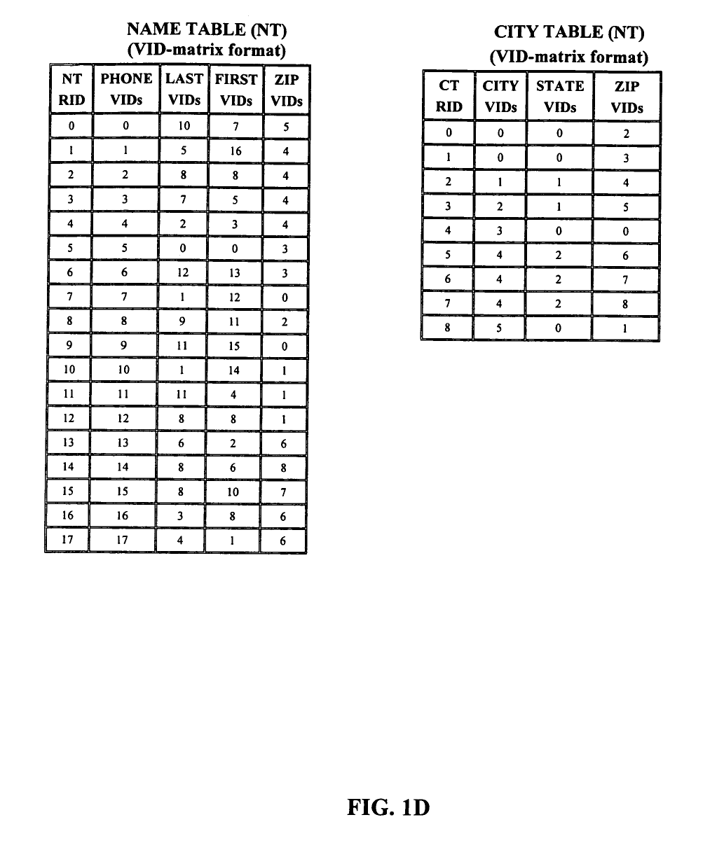

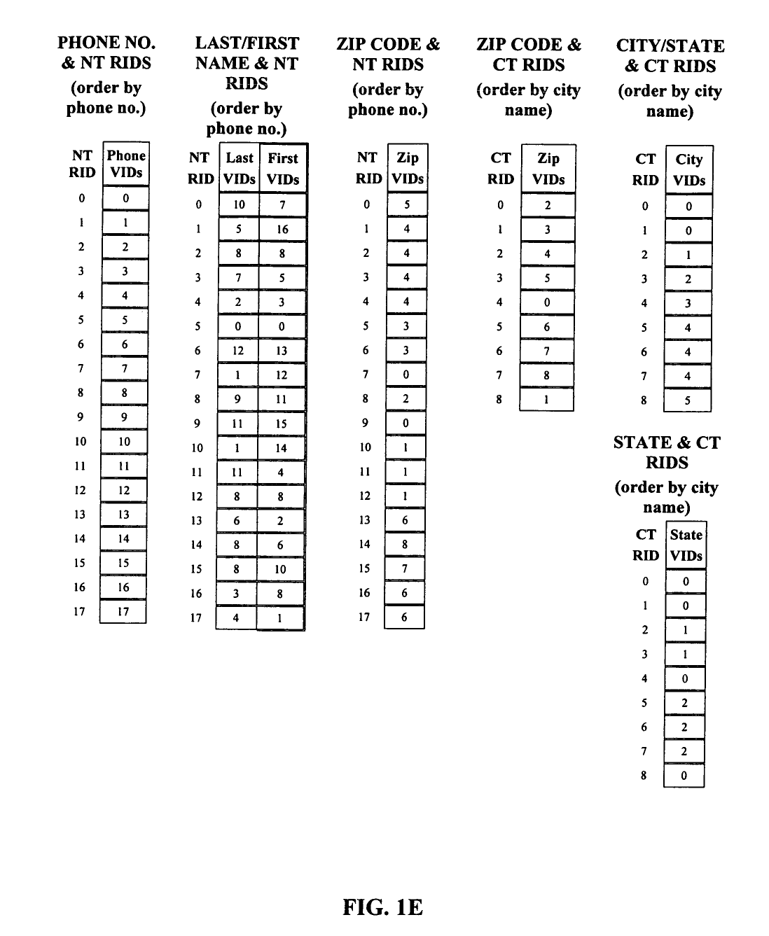

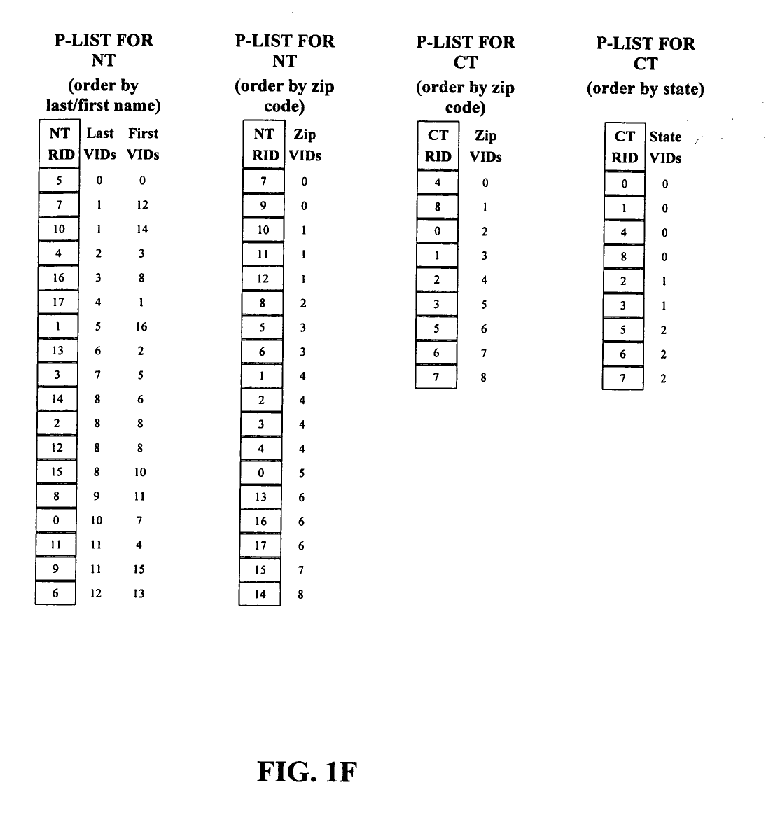

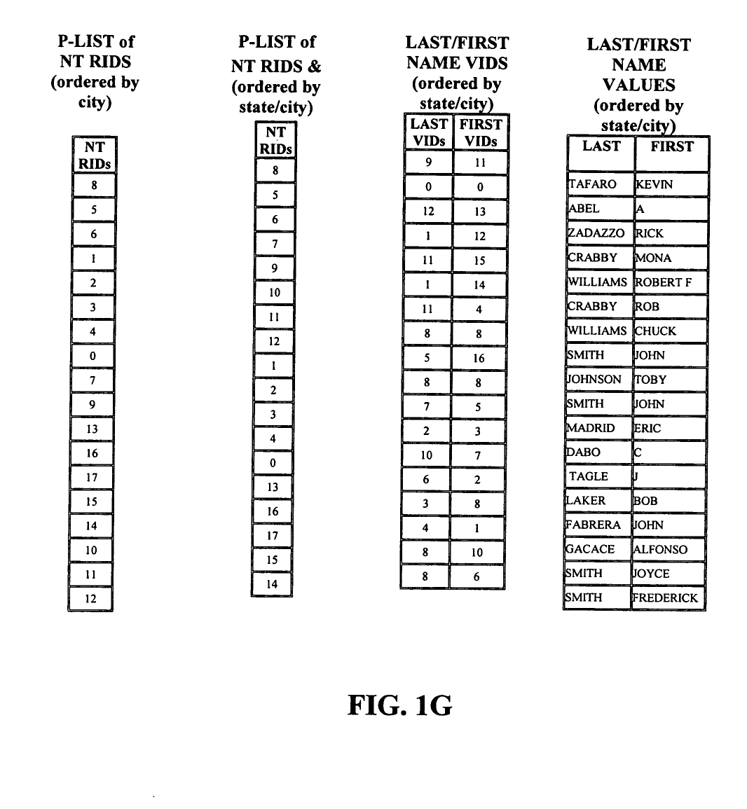

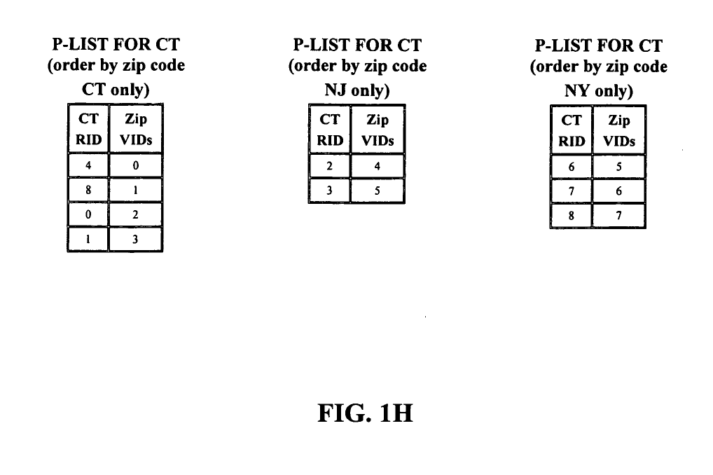

The exemplary database illustrated in FIGS. 1A-B is used throughout the following description. Referring to FIG. 1A, the name table (abbreviated herein as “NT”) holds the first and last names, phone numbers, and zip codes of individual of interest, and is sorted on the phone number. The city table (abbreviated herein as “CT”) holds the city and state for the zip codes of the NT names, and is sorted on the city. FIG. 1B illustrates the join (abbreviated herein as “JT”) of the NT and the CT on the zip code. This exemplary database may be considered as a much simplified example of a “data warehouse,” where the NT is a “fact” table and the CT is “dimension” table. It may also be considered exemplary of a portion of a customer or employee table in an operational database.

### Data Structures

In addition to database table, the present invention generates and stores auxiliary data structures that represent considerably reduced storage requirements and promote efficient querying.

### Row Identifiers and Row-Identifier Lists

A row identifier (abbreviated herein as a “RID”) within a table is generally a unique name or identifier for each tuple or row in the table. For a matrix-like or a list-like structure, a RID is a unique index that corresponds to a list element, a matrix row, or the like. For example, FIGS. 1A-B illustrate in a first column RIDs for the NT, the CT, and the JT, where, as is apparent, they identify each tuple or row of these relations. Generally, the RID is not explicitly stored as an element of the identified data structure. However, in addition to being an identification, a RID may convey additional information concerning a tuple, row, or element, such as information concerning its storage location. For example, if a RID is the address where the element identified by the RID is stored, the identified element may be retrieved from storage given the RID alone. Alternatively, if the elements are stored in a tree, a RID might identify the nodes that must be traversed to retrieve a given element.

RIDs may also serve as a form of table “connectivity information” in the sense that particular values of the attributes of a relation are connected together in a tuple if these particular values all appear at the same RID in various attribute columns. For example, in FIG. 1A, the phone number value “203-372-2738” at RID 8 in the phone number column is connected with the last name value “TAFARO” also appearing at RID 8 in the last name column; both of these are connective with the first name value “KEVIN” appearing a RID 8 in the first name column; and so forth.

A row-identifier list (abbreviated herein as a “RID-list”) is a list of row identifiers. For example, a list of unique RIDs, one for each tuple in a stored relation, defines a particular permuted order of the tuples in that relation. A list of RIDs for fewer than all the tuples defines a particular selection or filtering of tuples of the relation.

### Value Identifiers and Value-Identifier Lists

The value list (abbreviated herein as “V-list”) is a list of the unique values that are present in an attribute column of a database table, with each value being associated with a unique identifier (abbreviated herein as a “value identifier” or “VID”), organized in such a way that attribute values may easily be found from the associated VIDs and vice versa. In one convenient organization, a sorted list of attribute values will correspond with a sorted list of their associated VIDs so that binary searches may efficiently relate values and VIDs. In other organizations, the V-list may be tree-structured providing for a form of directory lookup; still further there may by a computable relation between values and VIDs; and so forth.

Each entry in a VID-list may be accessed by a single RID used in common across all columns; in the simplest embodiment this RID is simply the entry number. This need not be the case, as individual columns might be stored in alternate structures such as a linked list or tree, and furthermore individual columns might be compressed or otherwise modified, or actual values might be stored rather than VIDs. In some cases the RID would not be a simple index number. If they are not stored as lists, some means of retrieving the contents of a cell identified by a RID must be provided, and any such columnar data structure must provide for reconstructing or otherwise returning a value identified by a RID. Thus the RID serves as the connectivity information linking values stored separately into a given record.

Preferably, VIDs are also chosen for efficient storage. For example, they may be integers sequentially assigned to sorted values and optionally not stored or represented in a compressed format in the V-list. Further, the individual values of two or more attributes (potentially from the same domain) may be contained in a single shared V-list and represented by a single type of VID.

FIG. 1C illustrates exemplary V-lists for the attributes of the exemplary database, namely last name, first name, phone number, zip code, city, and state, including all the values present in the NT and the CT. These V-lists are simply arranged: the values appear sorted in alphabetic order; and the VIDs are sequentially assigned integers.

A value identifier list (abbreviated herein as a “VID-list”) is a list of value identifiers representing the values of one attribute of a relation, and generally, a set of value identifiers includes some or all of the VIDs for the tuples of a relation arranged according to some data structure. For uniformity and compactness, it is generally preferred to represent all values in the stored database of this invention by their assigned VIDs, although in other representations the actual values may be used for some or all of the attributes without replacement by VIDs. FIG. 1D illustrates the NT and the CT in a “VID-matrix” format where actual attribute values have been replaced by VIDs as defined by the V-lists of FIG. 1C. The database representation illustrated by FIGS. 1C and 1D contains the same information as the more standard representation of FIG. 1A. Note that even though all these structures are associated with each other, they need not be stored in the same file, or even on the same local node in a network of computers.

A database stored in a VID-matrix representation may additionally be partitioned either horizontally or vertically and the partitions stored instead of or in addition to the parent VID-matrix. Preferably, the partitioning is primarily vertical by columns so that the VID-matrix is decomposed into a set of smaller column-wise sub-matrices, each column-wise sub-matrix including one or more columns of the parent VID-matrix, and each column of the parent matrix being included in one or more of the sub-matrices. Advantageously, the sub-matrices include columns and groups of columns that are projected together in common database queries. Secondarily, one or more of the column-wise sub-matrices may be further partitioned horizontally into sub-sub-matrices, where each sub-sub-matrix includes one or more rows of the parent sub-matrix. Advantageously, the sub-sub-matrices include rows and groups of rows that are filtered together in common database queries.

It is assumed that any partitioning is such that any tuple in the original database representation may be reconstructed from one of more of the stored partitions. In a parent VID-matrix, each tuple is represented by a single matrix row identified by a RID. In a partitioned representation, for example, a column-wise partitioning, the tuple identified by a particular RID may be reconstructed using connectivity information such as that RID to retrieve the appropriate column list element.

FIG. 1E illustrates the exemplary database in such a column-wise partitioned store. In this figure, RIDs are illustrated for convenience; in one embodiment (as shown) these consist of a sequence of consecutive integers, and so are implicit rather than actually being stored. In this embodiment VID-list elements are selected by using the RID as an indicial number. Concerning the name table, phone number value-IDs are stored in an individual sub-matrix with the NT RIDS shown identifying the NT records corresponding to each phone number; last name and first name values are stored together in another sub-matrix shown with the corresponding NT RIDS, since first name is assumed to usually be retrieved in association with a last name; and zip code values are stored in a separate sub-matrix similarly to the phone number values. Concerning the city table, zip code values are stored in an individual sub-matrix, shown along with the CT RIDS identifying the CT records corresponding to zip code; city name and state name values are stored together in a separate sub-matrix similarly to the last name/first name values because they also are assumed to usually be retrieved together. In the illustrated partitioning, all sub-matrices are ordered by NT (or CT) RIDS as is the parent table. The matrices illustrated in FIG. 1E may also be horizontally partitioned as described. For example and especially for purposes of query performance, each sub-matrix of FIG. 1E may be decomposed horizontally by area code into a sub-matrix for area code 201 including NT RIDS from 0 to 4, a sub-matrix for area code 203 including NT RIDS from 5 to 12, and a sub-matrix for area code 201 including NT RIDS from 13 to 17.

The RIDS also provide the connectivity information for correctly associating attribute values from individual sub-matrices into tuples. In the exemplary embodiment, the phone number with a VID of 7 (203-371-9485 from FIG. 1C) corresponds to a last name with a VID of 1 (Crabby), a first name with a VID of 12 (Mona), and a zip code with a VID of 2 (06604), because all these VIDS are associated with NT RIDS of 7 in their respective sub-matrices.

### Intra-Table Permutation Lists

A set of data structures for permuting the order of the records to a new order is provided for. Such a permutation list (abbreviated herein as a “P-list”) comprises an ordered list of RIDs, the order being determined by the desired target order for the permuted records, which is typically the sort order of a given column. Such a list can be constructed by temporarily storing a sub-matrix with its corresponding RIDs, then sorting the VID-list according to the lexical (e.g.) sort order of the associated values. In the exemplary database the sort order of the VIDs for each attribute is the same as the sort order of the attribute values since VIDs are sequentially assigned to sorted V-lists. For example, the NT P-list ordered by last/first name is sorted first on the last name value, and for multiple last names, is sorted second by first name. Similarly, the CT P-list ordered by state/city is sorted first on the state value, and within states, is sorted second by city. As illustrated here, one or more of the sort columns need not appear in a P-list. FIG. 1F illustrates some of these structures. In the preferred embodiment, the associated VIDs are removed from the P-list and stored in Displacement-list structures, described below.

### Inter-Table Permutation Lists

Further P-lists may be usefully constructed that provide a sort order of first table in terms of attributes appearing in a second table (abbreviated herein as a “inter-table P-list”) when the table may be joined on a possibly entirely different attribute appearing in both tables. Thus, inter-table P-lists comprise a RID-list for a first table sorted on an attribute appearing in a second table.

Additionally, two tables may be joined through common attributes also appearing in a third table. When there are multiple tables, a reasonably complete set of simple permutations can be stored, for example, the set including one permutation list per joined-to table for each column in the database. Approximately, if there are a total of N columns distributed among M tables, the number of permutations that are needed equals M×N. This set of permutation lists forms complete connectivity information for the database, in that it provides a description of how to connect from any cell in a given column to relevant cells in any other column, on a column by column basis. Ideally, this fundamental connectivity structure is stored and maintained in its entirety, or at least the fraction referred to by expected queries.

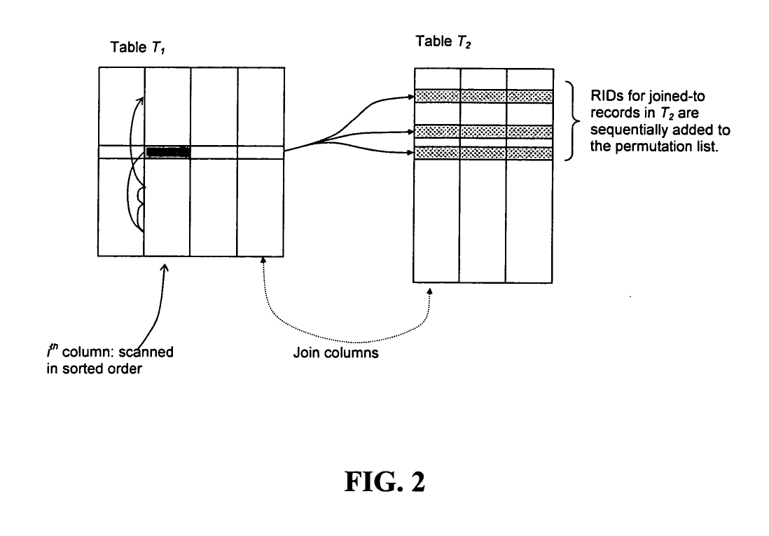

A permutation list between the two joinable tables may be computed by executing an intervening join between the tables in the manner illustrated in FIG. 2 and described below. To generate the permutation list for the sort order of the i^{th} column in table T₁ for rows in table T₂ where table T₁ is joined to table T₂ on a common attribute, for each value in a particular row of the i^{th} column, starting with the first value in i^{th} column's sort order (of table T₁) and proceeding down the sort order in table T₁ for all i^{th} column value, execute the join to table T₂ for that particular row in T₁. Then, add all RIDs from table T₂ that connect through the join to that particular row in T₁ to the permutation list in sequential order. The permutation list for this i^{th} column may be used for any column in table T₂. Scanning table T₁ in the i^{th} column sort order may optionally be aided by having an intractable P-list for T₁ in the i^{th} column sort order.

If the join column in table T₁ is a primary key, so that there is a primary key-foreign key connection between T₁ and T₂, the base table representation of T₂ can be stored in an order matching that of the join column in T₁. This leads to a reduction in the number of permutation lists that must be stored. Further, it is possible to avoid storing some clustered orderings of columns altogether if the ratio of the numbers of rows between the two tables is high enough. In cases where, for the most granular possible selection, the number of rows in the projected column(s) are still larger than the number of entries in a single seek-equivalent block, clustered access is unimportant since the same number of seeks must be performed.

Contents and construction of inter-table P-lists are illustrated with respect to the NT and CT and their join on their common zip code attribute, join table JT. With reference to FIG. 1G, the first sub-matrix with NT RIDs ordered by city may be constructed as just described. CT is traversed row-by-row in city sort order and each CT row is joined to the corresponding NT row by matching zip code fields. The RID of the matching NT row is then added to this sub-matrix. Traversal of CT is most efficiently performed by proceeding row-by-row down the zip code column ordered by city name, which may be found in the sub-matrix zip code & CT RIDS (FIG. 1E). NT RIDS corresponding to the zip codes may then be efficiently found from the NT P-list ordered by zip code (FIG. 1F). In other words, the inter-table P-list is nothing more than a composition of two sub-matrices, one a CT sub-matrix in city order and the other an NT P-list in zip code order where the zip-code is the join attribute.

Additional sub-matrices illustrate sorting of the NT table first by state then by city. The second sub-matrix is a P-list with NT RIDs sorted in state/city order and may be used to construct various partitions of the NT table also sorted by state/city. For example, the third sub-matrix illustrates the last and first name columns so sorted. For convenience, the fourth sub-matrix illustrates last and first name columns sorted in state/city order where, instead of VIDs, actual last name and first name values are used for the cell contents.

### Displacement Lists

The prior auxiliary structures are usually sorted on at least one column, and in some cases (for example, V-lists) on two columns. This sorting provides for efficient access by binary-type searches to individual values and rows. However, these structures may be supplemented by displacement or distribution lists (abbreviated herein as “D-list”) which improve the efficiency of both range and individual-item searches while reducing storage requirements.

Briefly a D-list associated with a sorted column of a matrix or a sub-matrix is a list of the unique values in the associated column and sorted in the order of the associated column. Further, each D-list entry includes the cumulative count of all prior entries in the associated column, that is the number of all entries sorted above the current unique column value. In other words, a D-list may be considered as a cumulative histogram of counting the values in a sorted column. In more complicated cases, it can involve the counts of combinations of values from more than one column. Then accessing a selected value in a column by means of an associated D-list is merely a matter of finding the selected value in the shorter D-list having unique entries (perhaps by a binary search) and then accessing the associated column beginning at the offset of the associated count. All selected values appear at or below the associated count. Further, because a D-list includes the numbers of each value, accessing a selected range of values merely requires accessing the associated column beginning at the count of the first value in the range up to (but not including) the count of the first value beyond the selected range.

In other embodiments, D-list may include the count of each values and not the cumulative count; may have a “1” offset instead of a “0” offset, and so forth. Modification of the described D-list access methods in these other embodiments will be readily apparent.

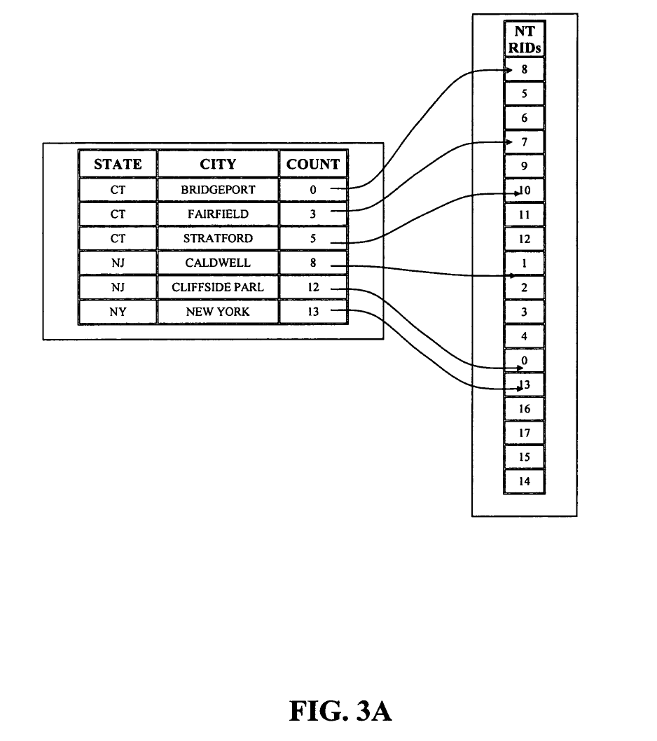

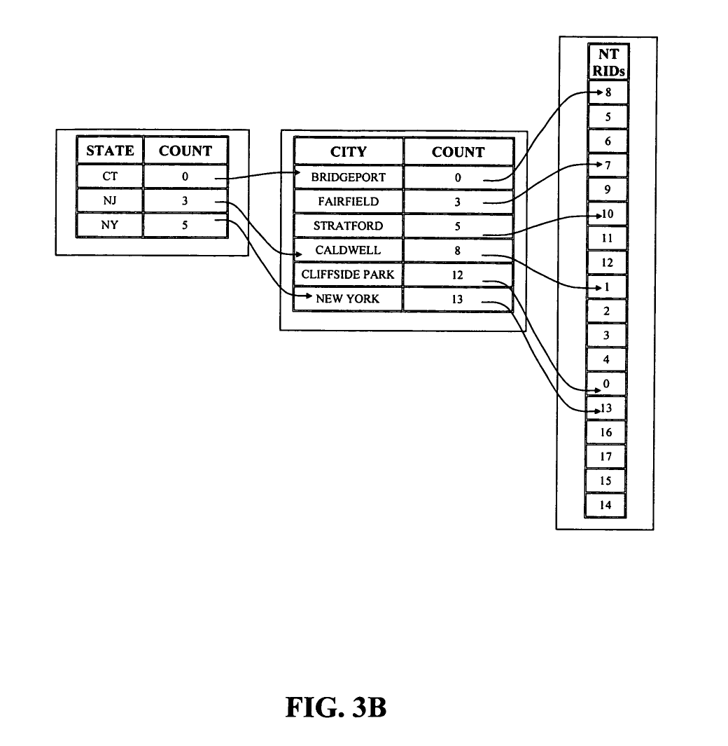

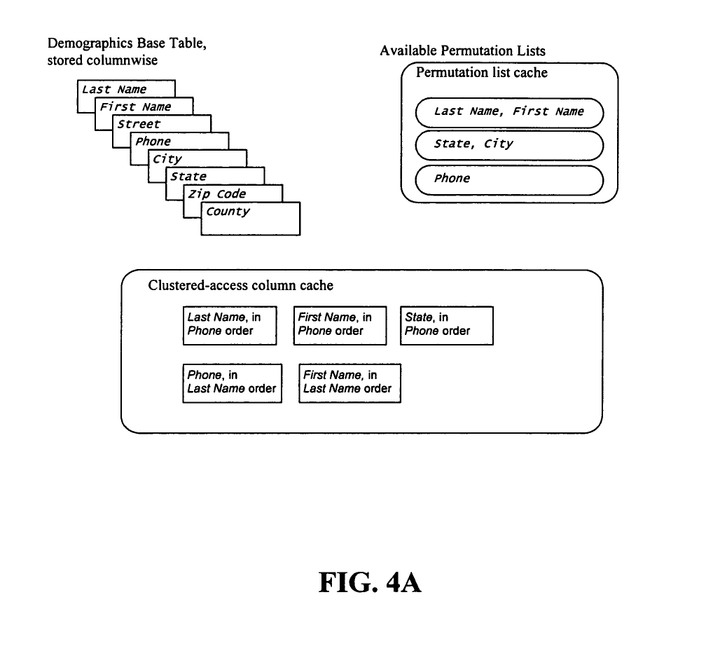

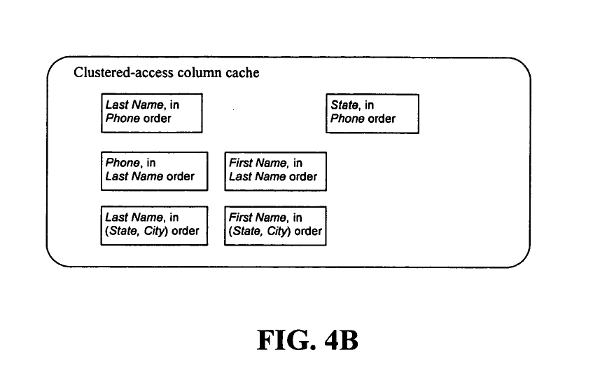

FIG. 3A-B illustrate exemplary D-lists that may be associated with the inter-table P-list having NT RIDS and city/state VIDS ordered by state/city. A first composite D-list may be constructed from this P-list by deleting the state VIDs and constructing a D-list from the city VIDs by deleting duplicate entries while retaining the cumulative count of entries as illustrated in FIG. 3A (for convenience the city VIDs have been replaced by their city name values). Thus, Bridgeport is the first city and is thus associated with a cumulative count of “0;” since Bridgeport has three entries, Fairfield is associated with a cumulative count of “3;” since Fairfield has two entries, Stratford is associated with a cumulative count of “5;” and so forth. Because the P-list was sorted, city entries appear grouped so that the D-list points to the NT RID-list as illustrated. Bridgeport entries begin a row “0;” Fairfield entries at row “3;” Stratford entries at row “5:” and so forth.

FIG. 3B illustrates a hierarchical D-list in which a second D-list has been constructed from the state VIDs in the parent P-list, which then allow access to the city D-list. Accordingly, duplicate entries are removed from the state VID-list and each remaining state entry is associated with a cumulative count of the number of unique cities in prior states in the sort order. Thus, because Connecticut is the first state with three unique cities, Connecticut is associated with a count of “0” and New Jersey, the next state, is associated with a count of “3;” and so forth for New York. These counts point to the city D-list as before.

### Horizontal Partitions

It is also possible to split table horizontally. This is base illustrated with an example of FIG. 1H. In FIG. 1H, The P-list of CT RID and ZIP VIDs is split by state. Accordingly, one horizontal partition contains data for Connecticut only, another partition for New Jersey only, and the third partition for New York only. Horizontal partitions may accomplish improved performance when the mix of queries is heavily dependent on a certain predetermined criteria.

### Use of the Above Data Structures

The present invention stores a master copy of a table. This table would typically be stored vertically partitioned—e.g. column-wise—on the disk. If any columns are identified as being usually accessed in sets, these columns might be stored together, so that the actual storage is not precisely column-wise; this makes no difference to the algorithms that follow. Usually a single column's VIDs are present in a single file or a contiguous part of a single file. Multiple columns' VIDs could be included in a file, however. Conceivably, the VIDs could be organized in some other way than a list.

Both intra- and inter-table P-lists are primarily used by the methods of this invention to construct (or “instantiate”) sub-matrices having VIDs (or actual values) sorted in the order of the P-list. The VID-containing sub-matrices are then used for query processing, instead of the P-list, so that the cost of resorting a sub-matrix according to a P-list is amortized over a number of queries. With a sufficient number of queries and especially with less selective queries, this is more efficient than indirectly referencing the VID-sub-matrices indirectly through the P-lists (which generally requires two separate IOs).

### Embodiment 1

A simple embodiment that enables clustered access on any column of a table T in any specified order is to store every possible sort ordering of T. In the preferred embodiment, every version of T is stored using the VID matrix technique described above. One column of the table, being in sorted order, is encoded using a V-list/D-list combination described above, and thus does not need to be stored as a VID list. This also provides for trivial access to any specified range of this table when it is queried on the sorted column (herein called the “characteristic column”). The total number of columns that must be stored in this case is N_{c} (N_{c}−1); that is, there are N_{c} copies of the table, each having N_{c}−1 columns (N_{c} being the number of columns).

Depending on the specific form of the database and the data contained, VID-matrix storage can provide dramatic compression over the size of the raw data; this enables, in roughly the same amount of space used by the original table, a large number of copies to be stored, clustered in whatever useful orders the system administrator or some automatic agent determines to be useful at a given time.

For a database with a large number of columns, or with data that does not compress well when converted to VID-matrix form, the next embodiment of the invention should be used.

### Embodiment 2

The present invention treats a reservoir of disk space as a cache. The contents of this cache are table fragments and permutation lists, partitioned vertically as well as horizontally. (A table fragment may consist of one or more columns.) The table fragments are typically single columns. The list of values stored in a cached projected column is permuted to match the order of columns used for filtering. A filtering operation on such a restriction column represents identifying ranges of entries in that column that satisfy some criterion. The goal of this invention is to have the most useful projected columns remain cached in the matching (or nearly-matching) clustered order of the most common restriction columns. This will make it possible to efficiently return the values corresponding to the selection ranges of the filtering criteria using clustered access.

Permutation lists for reconstructing the user's specified sort order on any column of interest would also typically be stored. These may be precomputed, at load time, or may be computed on an as-needed basis. A “column of interest” is one whose values (possibly filtered), will be returned (projected) during the course of a query.

The database contents for this clustered-access-column-cache architecture (single-table) example are illustrated in FIG. 3. FIG. 3a shows the state of the original, or “base” table, the existing permutation lists, and the cluster-cache contents, while FIG. 3b shows the state of the system after the query described above has executed. In generating this figure, it is assumed that there is sufficient room to store one new clustered-access column, but not two, so one of the existing columns must be aged out in order to accommodate the new ones.

As a run-time performance optimization, the most useful permutation lists or even a complete set may trivially be computed at load time, as a means of “priming” the overall system. Computing this “complete set” of permutation lists corresponds essentially to fully indexing a table in a prior art database, a not-insurmountable task.

To perform a query such that, first find all Smiths in New York, N.Y., a traditional database query processor would use an index similar to this permutation list to find that records 4, 5, 7, 10 and 12 all satisfy the (State, City) portion of the query. These records would then be retrieved by row number in the Last Name column, and tested to determine which of them if any correspond to individuals whose last name is Smith.

However, in many cases in traditional database architecture, and even more frequently when a table is stored column wise, it is advantageous to actually perform a full scan of the table, examining every record. (If stored column wise, this would represent a full scan of the Last Name column.) This is true when the selectivity of the filtering condition is such that there is likely to be more than one Smith per seek-equivalent block that is read in. Since a seek block size is on the order of 1 MB, and the width of 1 VID is likely to be something like 3 bytes (in a more realistic database), any queries having filtering selectivity's returning more than 1 out of 333,000 records are better-off done by a column scan; this is because on the average most if not every block must be touched. Note that once such a column scan must be performed, a second option is possible for performing the query: as each value is read, it is tested to determine if the Last Name matches Smith, and the relevant records identified this way.

When a full column scan must be performed, the incremental cost of generating a cached version that column in the appropriate clustered order is dramatically reduced. In fact, if the (State, City) permutation list is already in memory, the disk-IO cost of generating the permuted column of Last Name ordered by (State, City) is roughly only 2× the disk-IO cost of doing the query in the first place, assuming sufficient memory. This cost is due to performing the complete read of the VID column into memory (which must be done anyway), a permutation according to the permutation list, and a complete write of the permuted VID column back to the disk cache area. If the permutation list is not already in memory but must also be read from disk, then the disk-IO cost is roughly 3× instead. Thus, crudely, if the lifetime of a typical projected column in cache is sufficiently long that it would be accessed more than 3 times during that lifetime, and the typical restriction on that column is reasonably small so that it contributes a large time savings, it is cost effective on the average to generate and cache the column at an early point in a series of queries. Subsequent queries are then able to proceed by reading only the filtered part of the relevant projected column(s), resulting in a time savings proportional to the selectivity of the filtering criterion.

Note that in cases where the permutation of RIDs corresponding to a (State, City) ordering does not pre-exist and must actually be computed via a sort step, the overall cost of this series of queries increases, but there is still a point where it is cheaper to do both a) generate the permutation column, and then b) generate the permuted VID column. In addition, since the permutation of a particular table is likely to be of value to more than this series of queries projecting Last Name, the cost amortization of the sort step is born by fractionally more of the total query stream.

As a storage optimization, gains are possible if a hierarchical ordering of columns may be identified. In the above example, there is a hierarchy consisting of (State, City), which could be subsumed into a single embedded-sort permutation list that does not require the storage overhead of 2 separate lists. This would be a relevant optimization, because there will reasonably be extremely few if any queries wherein only the City but not the State is specified.

### Clustered Access Generally

It is the goal of this invention to provide for functionality that is equivalent or nearly so to that provided by storing the combinatorial multitude of the columns described above, without incurring the tremendous overhead of data-storage that would be required for columns that are rarely used. That is, as often as possible, when filtering by the columns that have the most selective criteria, achieving clustered access to those columns whose values are returned or evaluated by the actual queries is desirable.

The effect of the clustered access is to decrease the number of seeks and/or the amount of data transferred during the processing of the queries. This reduces the IO (and some CPU) time in a roughly proportional way to the decrease. Thus reading a certain amount of (useful) data from a clustered table will generally take only a fraction as long as reading the same useful data from an unclustered table. This fraction is roughly equal to the single field criterion “selectivity fraction” of the query—the fraction of records selected by a single field criterion out of the total number of records in the table. Note that an unclustered table in this context is one that is not clustered by the field involved in the criterion used for selection.

An illustration of this is shown in FIG. 1, using an embodiment in which each column of a user table is a separate file stored on a disk accessed by blocks. There is an “Original” or “Base” table, corresponding to a user table, that has 5 columns: A, B, C, D and E. The table, meaning all of its records, and therefore all of the rows of its component columns, has been sorted by column A, presumably because this had previously been determined to be a useful sort for many queries. Unless there is a strong correlation of the values of column B and column A, however, there is no significant sorting of column B by its own values. If the rows of column B that have values between v1 and v2 are selected (and blackened), such rows are seen to be distributed throughout the column file, at varying densities. If a copy of the column B file is sorted by its own values, those same rows are now located in one small, contiguous section of the file, at the highest density.

Even if the rows of column B that have values between v1 and v2 are already known, as from an inverted list or other index, the time to read these rows from the column B file sorted by column A will be very different from that of the column B file sorted by itself. Say the total number of rows is 1 Billion, those selected are roughly 10% of the total, and column B is 2 Bytes wide (about 2 GB total size). The file sorted by column A could have about 10 to 100 million separate selected rows and groups of rows. In addition, any one disk block will only have about 10% of its rows be selected. Thus there are so many seeks (20 msec/seek*10,000,000) that it would be faster to scan the whole file sequentially (100 MB/sec*2 GB=20 sec) and test the values of the rows to extract just those that meet the criteria. The file sorted by column B, however, would have very few seeks (in an ideal, simplified world, perhaps only one) and would just have to read 10% of the 2 GB=0.2 GB, taking 100 MB/sec*0.2 GB=2 sec. In addition, there is much more data that has to be evaluated and discarded in the unclustered case, increasing CPU costs as well. Thus the general rule is that the time to read a selected range that is a “significant” fraction of a clustered column compared to the time to scan all of a non-clustered column is just the selection fraction. On the other hand, for very small numbers of unclustered records, say 25, the time for the multiple seeks (20 msec*25=500 msec) will always be larger than that for the single seek required to access a block with all of the desired records (20 msec*1=20 msec), by a factor equal to the number of records selected.

If a query on the example table has criteria on a few different columns, and information is available that allows knowing or estimating the selection fraction (this may be available in an associated D-list), it should be determined which criterion is the most selective (has the lowest selection fraction). The most improvement in IO (and related CPU usage) is obtained if data columns available are available that have been sorted by the column with the most selective criterion. This will allow clustered access to the data columns and required the least blocks to be read, taking the least time for the (basic IO for the) query.

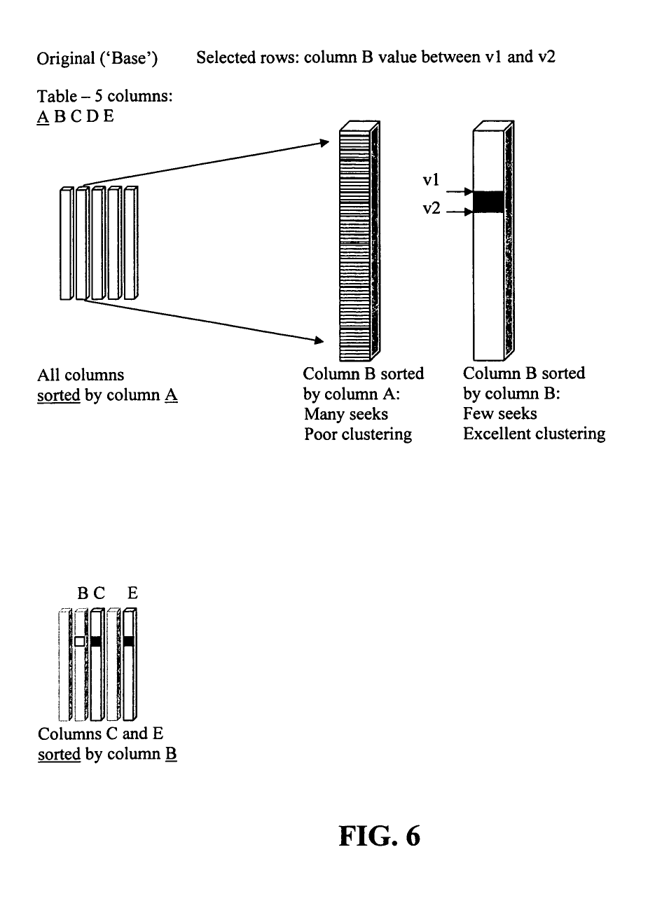

With reference to FIG. 6, given a query that returns values from column C and has criteria on column B and column E, with the more restrictive criterion on column B, a useful table fragment (that is, its columns) will be sorted by column B (at least) and contain column C (for projection) and column E (for criterion testing).

### Caching and Caching Methods

A database manager will typically reserve a given amount of storage space for use by the database management system for the data, indexes, and whatever other temporary or scratch structures are required. This storage can be on disk(s), tape(s), or even in RAM, depending on the size of the database. The goal of this invention is to use the excess space over that used to store the base tables to store what is technically redundant data in order to maximize the overall query throughput. This is done by storing a set of clustered fragments of tables to enable clustered access to the most important columns for the most frequently asked queries. If disk space is limited, this set of fragments will be optimized for a given data and query profile; this profile can be measured on the fly, and the stored objects instantiated and destroyed automatically, or it can be specified in advance, based on some knowledge of the database administrator. As disk space is increased, the number of queries that may be optimized for also increases, until for a sufficiently large amount disk space the stored table fragments are a complete set over all clusterings for all queries that are posed. The following discussion concerns algorithms for computing instantiation and destruction thresholds that maximize the benefit of using the excess disk space in this fashion.

First, a simple embodiment is discussed for pedagogical reasons. In this case, the objects instantiated (also “created” or “constructed”) in the cache are individual columns of the original base tables, ordered so as to match the sort-order of some other column. The next few paragraphs discuss various cache management strategies.

In general, some event or sequence of events causes such a column to be instantiated, while some algorithm decides which columns should be destroyed. In the simplest embodiment, the instantiation-triggering event is merely access: if a particular set of records is being filtered on column F with results being returned from column P (the projected column), instantiate and cache P in the sort order of F. In turn, a number of known cache management strategies can be used to destroy the cached copy of a column. A simple but useful strategy is to maintain the last access time of each column in the cache, and destroy sufficient numbers of the least-recently-used columns on an as-needed basis in order to make room for the latest P columns being instantiated.

In further embodiments described below, more knowledge is brought to bear on which P columns to instantiate and which to destroy. The cost of generating and maintaining various P columns in F orders can be balanced against the gain in throughput they bring to the overall mix of queries being processed. In this model, the amount of disk space serves as a constraint; the utility of a given column or columns is compared to the utility of whatever columns it or they would displace; if for equivalent space one column improves throughput more than several existing ones combined, the latter would be destroyed to allow instantiation of the one column. Alternatively, if the aggregate improvement to throughput resulting from several smaller columns outweighs that of a single large one, that large one would be destroyed to make room for the small ones. Those schooled in the art will recognize this as the well-known knapsack problem, which is NP-complete, and thus in the cases with large numbers of candidate columns may only be solved approximately. A number of known techniques exist for such approximations, see e.g. S. Sahni, Approximate algorithms for 0/1 knapsack problem, Journal of the ACM, 22 (1975), pp. 115-124.

In one embodiment, a utility U of a given column is defined by the ratio of time saved by having this column to an elapsed time. That is,

$$U = \frac{{T}_{saved}}{{T}_{elapsed}} .$$

T_{elapsed} represents the period over which, had this ordered column been present, the amount of time saved would have been T_{saved}. This utility is calculated for various time periods, for example, an hour, a day, a week (and also a month or a year). For each of the columns that are not clustered and for each relevant ordering of the columns, the cost of a submitted query (using known query-costing techniques and the existing mix of clustered columns) is estimated as if that clustered column were available. Relevant orderings are determined from the restriction criteria specified in the query. In one embodiment, trend information for each column is also accumulated in the form of pairs, (t_{accessed}, T_{saved}), where t_{accessed} is the time the given column was accessed. Either or both of two versions of T_{saved} are computed: the first is relative to the time the query would take in the baseline case, i.e. with an empty cache; and the second is computed accounting for the current cache contents. In a second embodiment, rather than storing all (t_{accessed}, T_{saved}) pairs, a limited number or possibly none of the pairs are stored, and only the summary trends are saved. As an example of such a summary number, the above T_{saved} values can be accumulated in a running average, with an emphasis on more recent computed numbers, as in the formula:

$$〈 {T}_{saved} 〉 = \frac{{T}_{saved} * α + {T}_{saved , this query}}{α + 1} .$$

In a further embodiment, α is adjusted on a slow time scale, depending on the churn rate of the ongoing mix of queries (i.e. might vary from 3 to 30). Churn rate is proportional to the number of new column additions per unit time. In addition, this information can be maintained on multiple time scales: i.e. [symbol] T_{saved} [symbol] _{hourly}, [symbol] T_{saved} [symbol] _{daily}, [symbol] T_{saved} [symbol] _{weekly}. These various averages are used to determine if the query mix starts to change drastically, and when it does whether it is useful to rely on shorter time-scale averages for the utility function.

As a second step in this embodiment, for each of the columns that are clustered, the cost of a query is estimated as if that clustered column was not available, and adjust T_{saved} for each of these. Similar statistics to the above are stored.

In one embodiment the above calculations occur in the background, so that at any given time a reasonably up-to-date version of the utility U is available or easily computable for any column. In another embodiment, these calculations are completed on a synchronous and deterministic basis as queries are entered.

The ongoing utility of all non-instantiated columns is measured and compared to the utility of those already in the cache. When a given column or set of columns has an aggregate utility larger than a set of 1 or more columns in the cache, they become candidates for displacing those 1 or more columns. That, is when the inequality U_{new}>U_{existing} is true, a net savings in processing time is expected, although this must be offset against the time to create the candidate cache entries. In one embodiment, creation time is ignored, and instantiate immediately when the above inequality is satisfied. In a second embodiment, the lifetime of the candidate set of columns is forecasted, and only displace if this prediction indicates that the column will last long enough to amortize its cost of creation. This forecast is accomplished, in one embodiment, by examining the trend information stored for each column and using it to project the future utility. In a simpler embodiment, it is assumed that the lifetime is a function of utility; in this case, the ongoing lifetime of the cached columns is examined having similar utilities and assume that the current column's lifetime will be the same.

In an alternate embodiment, a replacement event is not triggered on the simple satisfaction of the inequality U_{new}>U_{existing}, but instead include some time-hysteresis of the form:

U_{new}>U_{existing}+H(t)

where H(t) starts positive for a given new/existing comparison and decreases with time.

In another embodiment, the definition of the utility is modified to include an ad hoc priority that can be used to adjust the response of the caching algorithm. That is, instead of U as defined above, use U′:

U′=U×P

where P is an adjustable number. Setting P to a value greater than 1 would result in a given column or column set tending to stay in the cache, resulting in quicker response for queries accessing this column. Alternatively, if there was a one-time query that was known a priori should not be considered for the cache, the priority could be set to zero, with the result that this column or column set would never be able to displace an existing one.

### An Alternate Method of Computing T_{saved}

Assume there are N_{F} filter criteria and N_{P} projected result columns that need to be cached. In many cases, only high-cardinality columns must be cached on disk in specific clustered orders, since low-cardinality columns may be compressed or stored using known techniques such that they fit in memory and are thus randomly addressable. (Note that these clustering techniques may also benefit data structures stored in RAM, wherein sequential access can be as much as 10× faster than random access.) In the following, N_{P} only numbers these high-cardinality columns. However, N_{P} typically includes both the columns actually projected for inclusion in the result set, as well as all but one of the columns that have filter criteria on them, i.e. that are used to restrict the result set.

As an example of why this is so, consider a single table having columns C_{A}, C_{B}, and C_{P}, with a query such as find all C_{P} values where C_{A}=x and C_{B}=y. Of the two filter columns C_{A} and C_{B}, assume C_{A} is the most restrictive. In this case, the best performance is obtained when there is clustered access to both columns C_{B} and C_{P} in C_{A} order: only the relevant ranges of each column needs to be read from disk and processed. Processing consists of reading both C_{B} and C_{P}, with each C_{B} value being tested against y to determine if the corresponding C_{P} value should be included in the result set.

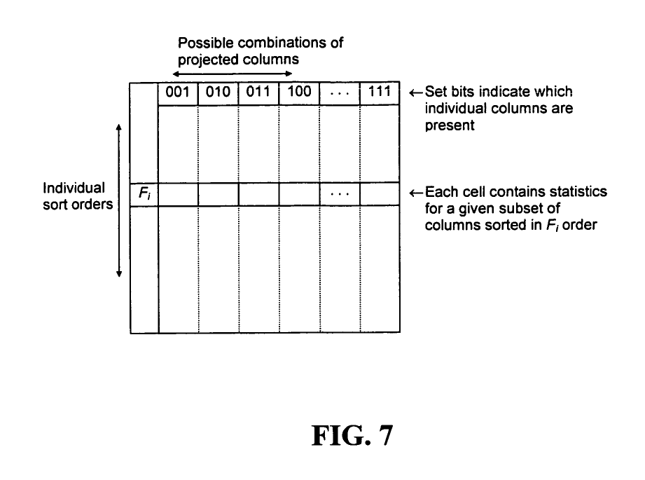

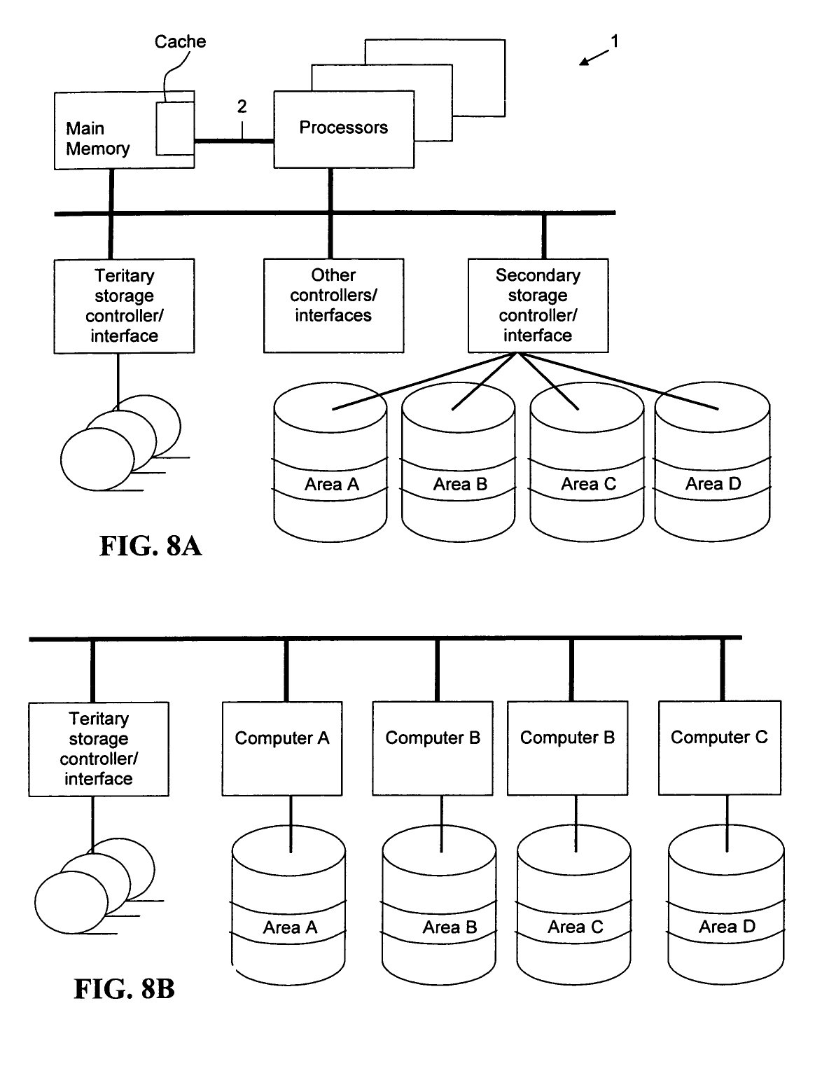

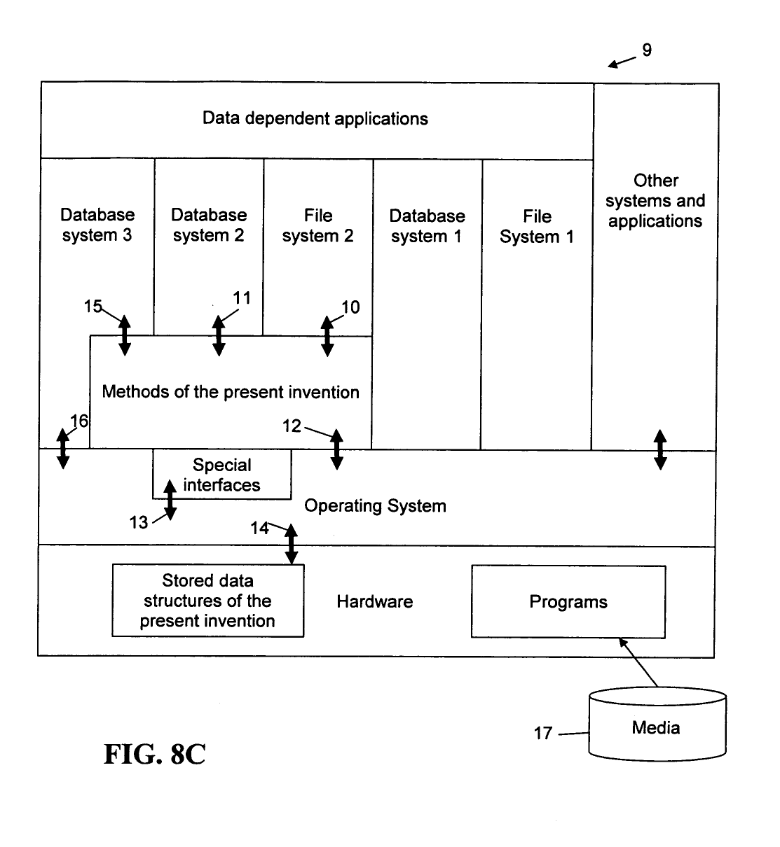

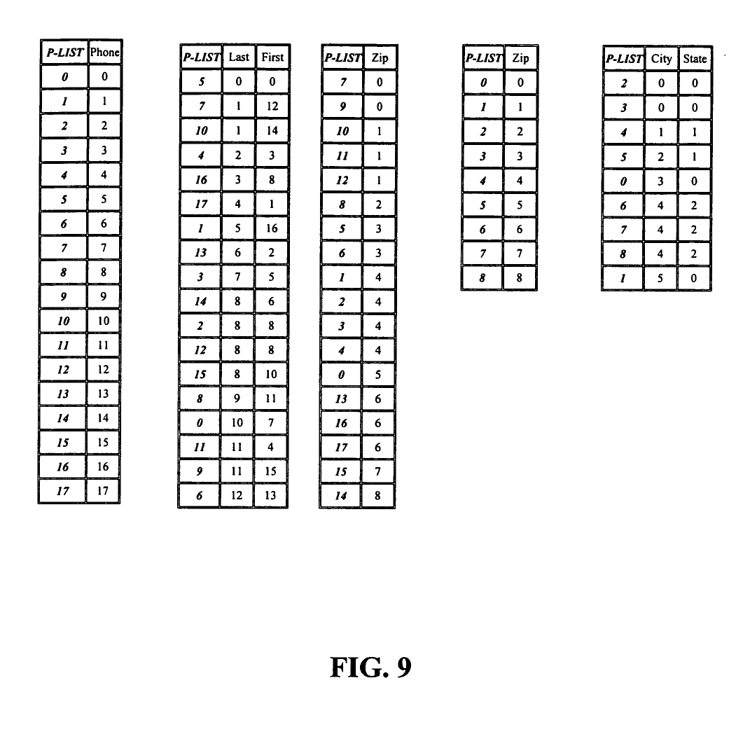

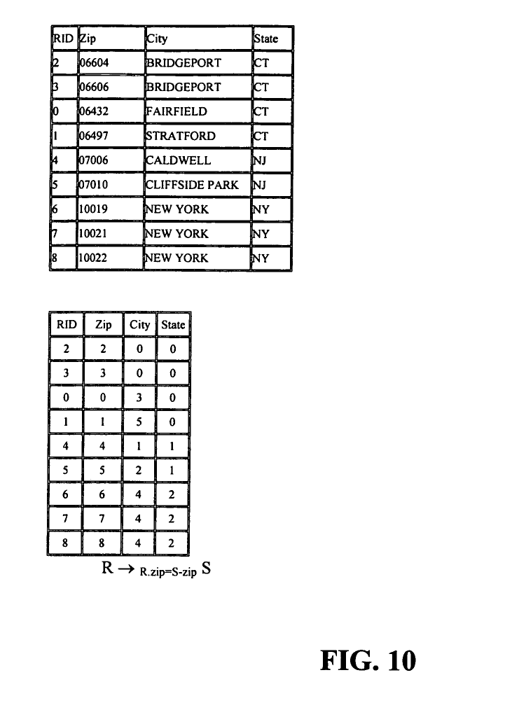

With a set of N_{P} projected result columns, there are 2^{N}^{_{P}} possible subsets of these columns. These subsets may be ordered according to any of the N_{F} clusterings that are best for the various filter columns. Thus there are N_{F}×2^{N}^{_{P}} possible ordered column-sets that might be instantiated in the cache. Conceptually, statistics about each of these possible combinations can be stored in a 2-dimensional array having N_{F} rows and 2^{N}^{_{P}} columns, as shown in FIG. 7.

In FIG. 7, information is stored in each cell in the table for evaluating an instantaneous utility function of the associated column set for the current mix of queries. In one embodiment, trend information is also accumulated in the form of pairs, (T_{accessed}, T_{saved}), where T_{accessed} is the time the column set was accessed and T_{saved} is the amount of time saved by having this particular column set available for use in the query processing. In one embodiment, T_{saved} is computed relative to the time the query would take in the baseline case, an empty cache; in another it is computed accounting for the current cache contents, i.e. relative to the query time with the columns currently available. The instantaneous utility and trend information are used by the cache controller to determine which columns should be present in the cache.

T_{saved} is computed from known costing techniques developed for query optimizers. As above, [symbol] T_{saved} [symbol] _{hourly}, [symbol] T_{saved} [symbol] _{daily}, [symbol] T_{saved} [symbol] _{weekly} or other information may be stored and used to determine if the query mix starts to change drastically, and when it does whether it is useful to rely on shorter time-scale averages for the utility function.

In one embodiment suitable for use when N_{P} is in the range 10-20, it is possible to store the above T_{saved} matrix directly. In an embodiment suitable for use N_{P} is substantially larger than this, sparse matrix techniques are used to only store the column combinations that are accessed.

Since there are a finite number of columns that must be evaluated for a given query, the number of cells that must be touched in the above matrix is relatively small compared to its size. For instance, if there are 6 possible projection columns (i.e. N_{p,this query}=6), there are 64 possible combinations that are considered for T_{saved, this query}. If the number of possible filter conditions is N_{F}=3, there are 192 cells that must be touched. For a time-stationary query mix, these column combinations will be repeated, and the fact that there may be a large number of unused entries in the T_{saved} matrix can be ignored: this invention will only be interested in the particular useful column combinations, i.e. those that occur frequently and save substantial amounts of time.

In another embodiment, the relative utility of each ordered column is separated and store this information for use by the cache controller. This is done by computing the above column combinations for the various relevant columns for a given query, but separately storing and accumulating their contributions to each column rather than for whole column sets. This particular strategy might be useful for, among other things, a query mix that results in somewhat random population of the T_{saved} matrix; in the case where the T_{saved} matrix has millions of entries, random column combinations resulting in modifications to 100s of cells would rarely overlap or be useful on the specific subset level, even though some individual columns might be particularly “hot”.

### Reduction in CPU Costs for Determining T_{saved}

In one embodiment, the following is an improvement in the amount of CPU time that it takes to calculate an approximation of the total amount of time saved in executing a query if the cache had a particular set of structures (such as column fragments sorted in particular orders). We can reduce the amount of CPU time for this calculation by not using the query optimizer every time that we execute a query. Instead, we run the query optimizer only the first time that a type of query is executed. In one embodiment, we can identify the type of query by the text of the query without the particular values of its parameters; the parameters are probably different for different executions of this type of query.

The first time that a given type of query is executed, the query optimizer does the processing described earlier in this patent. In particular, it estimates the time saved for each of many different sets of structures in the cache. In addition, we store the results of these calculations in, in one embodiment, a table. Let's call this table the query benefit table. Each row in the query benefit table has, in one embodiment, three columns.

The first column is the text of the type of query and the string of this text is the first part of a composite key column for this table. The second column is the other part of the composite key column for this table. It is the selectivity of the particular query (not of the query type) where selectivity is lumped into, for example, 10 levels of selectivity: 10%, 20%, . . . 100% of the size of the most restrictive column in the query. The third column of the query benefit table is the results of the query optimizer that was run the first time the query type of a particular level of selectivity was executed. In particular, it is the estimate of the time saved for each set of structures that might have been stored in the cache.

Instead of using the query optimizer to make all these estimates every time a query executes, we simply look it up in the query benefit table and pull out the estimates from the third column of that table. Typically, in the great majority of the times, it will already be in the query benefit table and thus we avoid a lot of CPU calculations of all these estimates.

### Horizontally Partitioned Tables

In many real-world databases, large tables in a database are horizontally partitioned. In this situation, the columns are similarly partition, storing only the fragments that are accessed per partition. In one embodiment, artificial partition-like divisions are introduced to further subdivide the columns into smaller fragments, and maintain statistics for each fragment rather than for the whole column or partition-slice of the column.

### Storing Column Groups

In a separate embodiment, the vertical subdivisions of the table that are cached are not individual columns, but several columns taken together.

### Updates

There are three components of the data structures that are stored for the cached cluster architecture: 1) the primary representation of the data, consisting of the original base-table columns, 2) the permutation structures that connect sets of filter (or selection/restriction) columns to sets of projected columns, and 3) the cached data structures representing permuted copies of these projected columns. All of these must be maintained in the presence of updates.

Maintaining the original base table and the permutation structures in the presence of updates is equivalent to maintaining the base tables and indexes of a traditional database, and is well-understood. Maintenance of the clustered-access column cache can be trivially accomplished by simply flushing the ones that need to be regenerated, as they become outdated.

However, for these particular data structures, there are more clever algorithms than are commonly used, that take advantage of the fact that the database is primarily static at any given time, with only a small fraction of the records being either inserted or deleted. That is, over the course of an “update cycle”, the bulk of the data appears to be read-only. An update cycle is defined below in more detail, but essentially consists of accumulating changes to the database in a “live” area, and slowly folding these changes into the larger (and more slowly changing) base tables. In sufficiently clever schemes, the individual existing structures do not have to be completely regenerated, but can be used as a shortcut to the final updated versions of those structures.

Maintaining one of the above structures in the presence of updates is roughly equivalent to maintaining a sorted list in the presence of modifications. There are a number of techniques available to do this. The simplest is simply to rewrite the entire data structure once a modification must be made. This can be made reliable in the presence of potential hardware problems by using and “old-master/new-master” technique, wherein a copy of the original structure is produced, with the desired modifications, and the original “old master” is only eliminated after the “new master” is completed and ready to be used.

However, unless the updates are exceedingly rare, recopying the entire list for each modification is unnecessarily burdensome. Furthermore, building up a sorted list in this fashion is an O(n²) process in the number of entries. An obvious extension is simply to batch together a number of changes that must be made, sorting them in the appropriate order, and merging the new (usually much shorter) sorted list into the new master as it is being copied. In addition, if the batch of modifications can also be queried, the fact that they have not been applied to the old master will not affect the overall results of queries, resulting in very low latency between requested modifications and their availability in the database.

In one embodiment, the copy from old-master to new-master takes place as a background process operating at an adjustable priority to guarantee that it completes before the next such merge is necessary. The priority of the merge process is dynamically adjusted depending on the arrival rate of records into the queryable queue. The priority will start relatively low, but will be increased as more and more resources are consumed by processing queries on the recent arrivals. The completion time of the merge process is projected based on the resources that it receives, to ensure that the overall query performance will never degrade to an unacceptable level due to the projected growth of the recent arrivals list in that time.

### Structure Regeneration During Updates

In a simple embodiment of the current invention (and more broadly any value-instance-connectivity) database, support incremental updates are supported. A simple method of updates is to incrementally load any new data into a new set of structures, and query both the old and the new sets of structures. When this becomes inefficient, this invention will merge all of the data into one set of structures. The following describes a simple method for doing this merge.

One embodiment of this invention vertically partitions what the user considers a table into separate files for each column (or group of columns that are often queried together). The values in the columns are replaced with VIDs, unique identifiers for each value, and stored as files called VID-lists. In the simple implementation discussed above, the VIDs are integers indicating position in a sorted list (the value list, or V-list). Counts of each value present, stored in sorted order of the values and cumulatively summed, called D-lists, are used as indicial numbers in a column that has been sorted by its values. Permutation lists, consisting of a list of the row ids (RIDs) containing a given value, ordered by value, can be used, along with D-lists and V-lists, as indexes into the VID-lists. In addition, they indicate how to sort a given unsorted column by its values. This type of implementation is the one that will be used for a description of merging.

Updates, consisting of “old” data plus “increment” data yielding “updated” data, require generation of updated structures. This will generally involve merges and replacements of old and increment structures, a reading in of old and increment structures and a writing out of the updated structures, referred to as “regeneration”. It is assumed that both old and increment data already have separate sets of existing structures, which will be used to regenerate a single set of structures for the updated (old plus increment) data. The modifications are not done “in place”; a simple implementation will use a “new master—old master” method: once the new structures are completed, changes are made in the system catalog to indicate the new structures, and the old structures are deleted. If there is some problem that causes the regeneration to fail (such as a power failure), the partially regenerated files are deleted and the process is just repeated until complete once corrective measures have been taken.

The structures considered here are the basic V-list, D-list, VID-list and Permutation list files, where a set of VID-list files—one per column—make up a disjoint starcore, the encoded representation of user table or table fragment. There will usually be multiple starcores for a given table, each one sorted by its “characteristic column”. (Note: The sorting may be by some subset of the columns, as opposed to a single column, a case that may be handled similarly with minor changes.)

It is assumed that RIDs (Row IDs) are not arbitrary, and are instead assigned after the sorting by the characteristic column. The following should also work if the RIDs are arbitrary, with minor changes.

1. Merge of V-List

This is the simplest regeneration: a simple merge of already sorted lists that fit in memory.

| V_{old} | V_{inc} | V_{upd} |
|---|---|---|
| V_{old-0} | V_{inc-0} | V_{upd-0} |
| . | . | . |
| V_{old-i} | V_{inc-i} | V_{upd-i} |
| . | . | . |
| . | V_{inc-m} | . |
| . | | . |
| . | | . |
| V_{old-n} | | V_{upd-n} |

Basically, V_{old} and V_{inc} are alternately traversed sequentially from their beginnings in order of increasing value. A given sequence in one file ends when the next value would be greater than the last value read from the other file; at this point the next sequence is read from the other file. The sequences of values, with no duplicates, are copied into V_{upd}

Steps:

```
Set i = 0, j = 0, iprev = 0, jprev = 0, kprev =0
Do while i <= count of V_{old} −1 and j <= count of V_{inc} −1
    if V_{old}(i) = V_{inc}(j)
        increment i and j
    Else if V_{old}(i) > V_{inc}(j)
        Do while V_{old}(i) > V_{inc}(j) and j < count of V_{inc} −1
            increment j
        Loop
        copy V_{inc}(jprev) through V_{inc}(j − 1)
        to V_{upd}(kprev) through V_{upd}(kprev + j − 1 − jprev)
        Set jprev = j, kprev = kprev + j − jprev
        Increment j
        Increment i
        If j = count of V_{inc} −1
            Copy V_{inc}(j) to V_{upd}(kprev)
            Increment kprev
        End if
    End if
Else if V_{old}(i) < V_{inc}(j)
    Do While V_{old}(i) < V_{inc}(j) and i < count of V_{old} −1
        increment i
    Loop
    copy V_{old}(iprev) through V_{old}(i − 1)
        to V_{upd}(kprev) through V_{upd}(kprev + i − 1 − iprev)
    Set iprev = i, kprev = kprev + i − iprev
    Increment j
    Increment i
    If i = count of V_{old} −1
        Copy V_{old}(i) to V_{upd}(kprev)
        Increment kprev
    End if
  End if
Loop
If i <= count of V_{old} −1
    copy V_{old}(iprev) through V_{old}(count of V_{old} − 1)
        to V_{upd}(kprev) through V_{upd}(kprev + count of V_{old} − 1 − iprev)
End If
If j <= count of V_{inc} −1
    copy V_{inc}(jprev) through V_{inc}(count of V_{inc} − 1)
        to V_{upd}(kprev) through V_{upd}(kprev + count of V_{inc} − 1 − jprev)
End If
```

The assumptions for an incremental load of a high cardinality column would be that:

1. the old V-list is much larger than the incremental V-list

2. insertions will generally be widely separated, and not be in long, sequential runs. This would not be the case for a column whose values are related to the increment—for instance, a “transaction_date” field that is related to increments loaded over time.

Different assumptions could modify the above algorithm, for example, by simply appending V_{inc} to V_{old} (with checking) if it were known that the increment values should all be greater than the old ones.

2. Merge of D-List

This is a moderately simple regeneration. As with the V-list, D_{old} is interleaved with D_{inc} and copied piecewise to D_{upd} at each insert. There are two additional components:

1. Positional: For a V_{inc} value that is present in V_{old}, increment the value of D_{old} by the count of D_{inc} for that V_{inc} value before copying to D_{upd}. For a V_{inc} value that is not present in V_{old}, insert the D_{inc} count value into D_{upd} following the insertion patterns of the V-list merge.

2. Cumulative summing: increment the D_{upd} values after each insertion by the sum of the previous insertions.

For certain databases, it may be faster to just convert the D_{old} and D_{inc} into Count-lists first (count-lists being lists of the numbers of repetitions of each unique value), increment or insert the D_{inc} counts into the D_{old} counts, and then generate a standard (cumulative) D_{upd}. Even a single insertion early in D_{old} will necessitate incrementing all of the D_{old} values following it, so that there will not be many more additions if all of the counts have to be added, as opposed to only adding the counts from D_{inc} to cumulative values in D_{old}. However, there may also be a performance benefit to using the cumulative format because there will be fewer different numbers to be added.

| D_{old} | D_{inc} | D_{upd} |
|---|---|---|
| D_{old}0 | D_{inc}0 | D_{upd}0 |
| . | . | . |
| D_{old}i | D_{inc}i | D_{upd}i |
| . | . | . |
| . | D_{inc}n | . |
| . | | . |
| . | | . |
| D_{old}n | | D_{upd}n |

Since the insertion-or-summation pattern of D-list regeneration is the same as the insertion-or-original pattern of V-list regeneration, it may be advantageous to keep some record of which V_{inc} values were inserted where in V_{old} to produce V_{upd}. This could be a “row insertion list”, a list of positions in one list after which the next value in another list has been inserted. All that is needed is the position in V_{inc} whose value was inserted after a given position in V_{old}. It is possible that if V-list regeneration were concurrent with D-list regeneration the necessary indicial information could just be read out and used by the D-list process as it occurs for the V-list.

The remaining structures to regenerate, the column structures VID-list and Permutation list, differ from the V- and D-lists in three ways: they are generally not sorted by their values, all columns' structures have as many elements as there are rows, and they may require one or two large “replacement” type list to be in memory (direct lookup).

The first step in one way of processing VID-list and Permutation list files is to determine and store the correspondence between RID_{old}, RID_{inc}, and RID_{upd} values. To determine the new RIDs, the invention starts with the “characteristic column” of a starcore (the column that starcore is sorted by), its updated D-list D_{upd}, and its Permutation list file. The RID correspondences will of course hold for all of the other columns in that starcore. Again, the interleave information can be stored in some type of row insertion list, or a full replacement list can be generated.

3. Regeneration of Permutation list (of characteristic column):

A column's Permutation list is a list of RIDs resulting from sorting the rows of a VID-matrix by the VIDs in that column and then sorting the RIDs within each VID. The RIDs are of course always unique. For the characteristic column, the RIDs will always be sorted and contiguous. So, for the characteristic column only:

The D_{inc} and D_{old} give cumulative counts for the number of RIDs within each value in Permutation list_{inc} and Permutation list_{old}. Using the same V-list insertion-or-original information that was used to generate the D-list, these two Permutation list files can be read sequentially, their RID values modified, and the results copied to the Permutation list_{upd} file. Permutation list_{inc} RIDs for new values can be modified and then inserted between those for existing values in Permutation list_{old}. Permutation list_{inc} RIDs for existing values can be modified and then appended to those already present in Permutation list_{old}. Generally, the Permutation list_{old} RIDs must also be modified before copying into Permutation list_{upd}. The modification in each case is that the resulting Permutation list_{upd} RIDs are sorted and contiguous.

As RID modifications are made, an RID replacement list (or possibly an insertion list) should be generated describing what the RID values from Permutation list_{old} and Permutation list_{inc} are to be changed to in Permutation list_{upd}. This information will hold for all of the Permutation list columns in this starcore. It will also be used to shift the rows of VIDs in the VID-list files (see below, Step 5.1).

4. Regeneration of other Permutation list columns (non-characteristic columns)

Again there are two components, the positional and the value (RID) conversion. In a given column's Permutation list file, the RIDs are sorted by the values of that column and then by the RIDs within it. In a non-characteristic column the RIDs will in general no longer be contiguous, since they were determined by the sorting of a different column.

1. Positional: The V-list insertion-or-original information, along with the D-list, are used to determine how many rows from Permutation list_{old} and Permutation list_{inc} are present for each value as they are inserted or appended to build Permutation list_{upd}.

2. Conversion: The RIDs of both Permutation list_{old} and Permutation list_{inc} are converted and then sorted before copying to Permutation list_{upd}. Although they can be read in sequentially, the whole replacement list (or insertion list) needs to be in memory because the RID values themselves are unordered.

5. Regeneration of VID-list columns

These columns are the VIDs in RID order. For the characteristic column, the VIDs will be sorted and contiguous. For the other columns, the VIDs will generally be unordered.

1. Positional: Referring to the RID replacement list generated previously (step 3), the rows from VID-list_{old} and VID-list_{inc} must be copied to the updated position of those rows in Permutation list_{upd}. There will be some approximate order here; since only a relatively small number of rows are being added, the new position of a row cannot be that far away from its original position. This may enable efficiency even if the whole RID replacement list is not in memory, but is read in sequentially.

2. Conversion: The VIDs in VID-list_{old} and VID-list_{inc} must be converted to the updated VIDs. There will be no order here, so even if the VID-list files are read and written sequentially, the V-list conversion information must all be in memory.

The two steps above can probably be done in sequence (either order) on pieces of the Permutation list file read in sequentially and written out sequentially without writing any intermediate files.

### Transaction Support

A transaction must pass the “ACID” test. “A” is for atomicity and that means that either all the updates in a transaction are applied to the database or none of them are applied. “C” is for consistency and that means that after each transaction completes the database still follows any rules that it is supposed to follow. “I” is for isolation and that means that each transaction does not see the effect of any incomplete transaction even though many transactions are running concurrently. “D” is for durability and that means that once a transaction commits then its effect survives even if there is a subsequent system crash.

The invention can support transactions using techniques known to those skilled in the art. For example, two techniques are the use of a transaction log and the use of a logical lock manager. Atomicity occurs by the write to a transaction log of a single log record that indicates the commit or abort (i.e. completion) of that transaction. Isolation occurs by the use of a logical lock manager that read or write lock records that are read or written by the transaction. These locks prevent other transactions from reading or writing them until the transaction holding the locks releases the locks (typically when it completes). A novel use of a logical lock manager is to lock individual fields of an individual record instead of locking the entire record. This finer granularity of lock increases the amount of concurrency allowable for the database. (This discussion applies as well to other modes of locking, e.g. intention locks). Durability occurs by writing a description of the transaction to the transaction log and flushing that description to disk before considering the transaction to be complete. Consistency occurs as in the traditional database because the user application implements their transactions to preserve the database rules.

### Systems and Methods

Generally, the transforms and internal representation described above organize suitably encoded data in serial-type (and parallel-type) memories accessible by single computers or by computer systems. These memories may be either system components or removable. Further, methods for performing these transformations are generally implemented in software components, which are part of operating systems or database subsystems, or applications, or so forth. In the following, particular types of hardware, software and memories are described as illustrative of the domains of applicability of the transforms and structures of this invention.

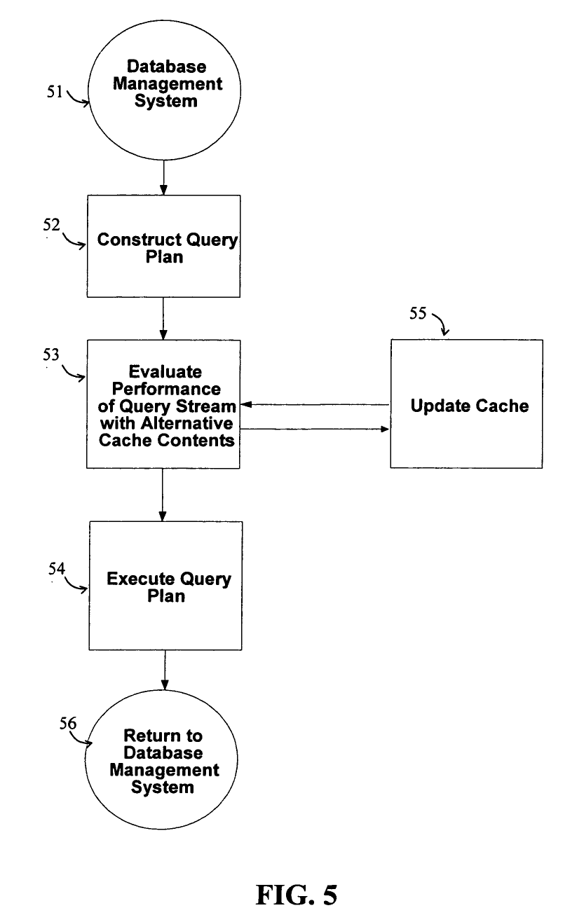

FIG. 5 illustrates an embodiment of this invention's cache acting as a subsystem of a database management system. 51 represents the database system, which at some point receives a query from a user. That query is used to construct a query plan, 52, which in turn is presented to the cache controller, 53. The cache controller evaluates the various statistics described in the text, comparing alternate proposed cache contents against the existing contents to evaluate the utility of a change. If some utility threshold is exceeded, the cache is updated, 54. The query is next executed against the (possibly updated) cache contents, 55, and control returns to the database system, 56.

### Computer Systems

The present invention is applicable for use with virtually any application or system that processes stored data in record-oriented logical formats or the equivalent, such as, for example, relational database (RDB) systems with process tuples or file systems which process records. In prior applications or systems, data processed in record-oriented logical forms was generally also stored in record-oriented physical forms, such as, for example, relations of RDB systems stored as files of fixed-format records. The present inventors have discovered that such record-oriented physical storage, while easily understood and simple to implement, has numerous disadvantages.

Accordingly, the present invention replaces record-oriented physical storage with much improved storage structures that achieve numerous improvements over prior systems, some of which are described above and others of which will appear in the following description. Description and understanding of these storage structures and of their consequent advantages is promoted by the consistent use of certain terms which, although known in the art, are now defined for the purposes of the present invention. Database and file systems have structures, which conveniently store and retrieve data in a semantically meaningful manner, and can be conventionally described as a series of structural levels with particular views describing the interfaces between the levels. Typically, there is first a physical level including the actual memory devices in a system, and an accompanying physical view describing how data blocks are actually arranged and positioned in physical memory. Next is a stored-record view describing the logical structures and formats for data in physical storage. For example, if a stored-record view includes a tree structure, then the physical view may describe how the data for the leaves and nodes of the tree is placed in storage blocks and how the storage blocks are placed in physical storage. Next, an external-record view describes the format by which data is exchanged between the stored-record view and higher structural levels. For example, a linear list of data elements may be an external-record view for a tree structured stored-record view that stores the data elements in a binary tree. Finally, there are more general levels and views, such as a conceptual level and an accompanying conceptual view (or data model) describing how the end-user logically sees the data, and accompanying functions which provide user database of file functionality. The physical and stored-record levels are collectively referred to herein as “internal levels”, while all more general levels are referred to as “higher (or external) levels”.

For example, the currently most common conceptual-level view for databases is the relational view (or model), which represents data as one or more relations (or tables), each relation having a fixed number of one or more tuples (or rows) with each row composed of one or more attributes (or columns) having values from a pre-determined domains. For files, the conceptual level is usually substantially similar to the stored-record view, if they are distinguishable at all. A most common file view (also called a file format) is a file of records composed of a fixed number of one or more fields of pre-determined types (fixed format records), the storage requirements of various data types possibly varying (for example, a variable-length character string). The obvious correspondence between relations and files of fixed format records has heretofore been virtually universally exploited to define the storage structures of relations in relational databases.

In terms of this conventionally-described software design hierarchy, the present invention is generally applicable and directed to implementation at the physical and the stored-record (or external-record) levels. It can completely replace the “internal” levels in existing database or file systems, or alternatively, new “higher levels”, with database of file functionality can be built on top of the present invention in a manner specially adapted to structures of the present invention. This invention preferably exchanges date with the “higher levels” using record-oriented structures, that is data structures defined by fixed numbers of “fields”, each field of a determined data type, and relations between fields being established by their presence in one record-oriented structure. In general, the present invention is applicable to any system having such a record-oriented interface between main memory and secondary memory. This invention is preferably applied to replace the internal levels in relational database systems, and for concreteness of description the following description is largely directed to relational databases

Similarly to the software design hierarchy, computer storage design, including main memory and secondary storage, can also be conventionally described as a hierarchical series of storage levels. At the “highest” level is main memory, which is directly accessible to a processor, is sized currently up to a few gigabytes, and has largely uniform access times of substantially less than one microsecond (ignoring cache and network memory effects). The next hierarchical level is secondary storage, which is currently usually composed of magnetic disks, is sized up to perhaps 10 to 100 terabytes, and has non-uniform access time of from 1 to perhaps 15 milliseconds. Finally, at the “lowest level” is tertiary storage, which can store hundreds of terabytes but with access latencies of several seconds to a minute or more.

In terms of this hardware design hierarchy, the present invention preferably partitions its data structures between main memory and secondary storage in a layout providing for rapid access with minimum space utilization. Therefore, again for concreteness, it is described herein principally in terms of these levels of the storage hierarchy. However, it will be understood by one of skill in the art in terms of the subsequent description that the present invention can be immediately applied to store data in only a single level—such as either main memory, or secondary storage, or tertiary storage, or other level of the storage hierarchy—or in any pair of hierarchical levels—such as secondary and tertiary storage instead of main memory and secondary storage, or in other arrangements suitable for particular applications.

### Exemplary Hardware Architectures

The present invention can be applied in a wide range of computer systems, from a single PC or workstation-type system to more complex systems, such as exemplary multiprocessor-type computer system 1 illustrated in FIG. 1A (also known as a shared memory or tightly-coupled multiprocessor), or exemplary cluster-type computer system 4 illustrated in FIG. 1B (also known as a shared nothing or loosely-coupled multiprocessor).

Multiprocessor system 1 includes one or more processors connected to a main memory (the first level of the storage hierarchy) by memory bus 2. Secondary storage devices, here conventional magnetic disks, are independently connected to a storage controller, then to I/O bus 3, and then finally to main memory. The independent connections permit simultaneous (or parallel) operations to take place on the attached disks, possibly even simultaneous data transfers from two or more disks. System 1 are includes tertiary storage (the third level of the storage hierarchy), here represented as a library of magnetic tapes (or, alternately, of CD-ROMs). Finally, the other controllers/interfaces provide for, inter alia, operator and network communications. This type of system is typically packaged and considered as a single system. Another analogous architecture is a shared-disk system which differs from system 1 in that each processor has its own memory but all still share storage controllers connected to common disk devices.

Cluster system 4 as illustrated in FIG. 1B comprises four separate computer systems (Computer A-D), each with private secondary storage, which is here illustrated as magnetic disks. Each computer system is capable of independent functioning, having one or more processors and private main memory, and communicates with all other systems over shared interconnect 5 for the exchange of data and control messages. The shared interconnect can range from a standard Ethernet to a specialized high-speed bus. System 4 can also include shared tertiary storage arranged to communicate with all the computers over shared interconnect 5. A cluster system is typically packaged as a collection of separate computers, possibly distributed, and often appears to users as multiple systems.

In further detail, areas A-D of the disk devices illustrated in FIGS. 1A-B illustrate sample contiguous allocations of disk storage. In a contiguous allocation, all allocated disk blocks are stored consecutively on sequential tracks and cylinders without any gaps, such as might be occupied by, for example, another an extent of another data set or by free space. It is well known that, after a first disk-seek latency of perhaps 1 to 15 milliseconds during, sequential access to the data blocks in a contiguous allocation can proceed at virtually the maximum disk transfer speed without any interruptions (ignoring the small delays due to inter-block gaps and to seeks from one cylinder to an immediately adjacent cylinder). The data structures of this invention are designed and preferably allocated on disk so that such access, called “streaming” herein, can be used to achieve disk access speeds approaching main memory access speeds.

Another technique for increasing disk access speed, known herein as “data striping”, spreads related data blocks across multiple independent disk devices. For example, related data blocks can be striped across these four disk devices illustrated in FIGS. 1A-B into areas A-D. The following example illustrates how striping increases access speed. If a first request for a certain data block stored in Area A is followed closely in time by a second request for another data block stored in Area B, then, because the separate disk devices with areas A and B are independent, part or all of the processing of both these requests can by overlapped and can proceed simultaneously. To improve the chances that random requests for related data are satisfied by data blocks stored in different areas, data blocks can be allocated randomly with respect to expected access patterns among the available disk devices

### Software Systems

FIG. 1C illustrates, in a standard fashion, an exemplary software structure 9 for a computer system (such as the systems illustrated in FIGS. 1A-B) in which the present invention is implemented. System hardware is generically illustrated here by the bottom rectangle, and is understood to include storage facilities for the data structures of the present invention (in an appropriately encoded format). The hardware is controlled across interface 14 by an operating system, either a general purpose operating system, such as Linux, Solaris (Sun Microsystems), or Windows NT (Microsoft), or so forth, or a special purpose, for example, directed to use as an embedded system. Data-dependent user-level applications use the facilities of database system 1 and file system 1, which in turn use the facilities of the operating system, to provide data and file access. Non-data-dependent application can interface directly to the operating system.

Legacy database and file systems 1 do not take advantage of the present invention, since they interface directly with the operating system. However, database and file systems 2 exchange data with hardware storage devices only by means of the methods of the present invention, which perform retrieval, update and storage of data in hardware storage devices in response to requests from the client (or supported) systems. Interfaces 10 and 11 between the methods of the present invention and these client subsystems are at the stored-record (or, equivalently, the external-record) level, or equivalent and are thus substantially similar to the exchange of fixed-format record-like data structures, as described above. The methods of the present invention then interface with the operating system using standard interfaces 12 (such as a file I/O interface). Alternatively and especially to achieve increased control and increased disk access performance, the methods of the present invention can interface with internal interfaces 13 of the operating system “close” to the actual storage hardware (such as the raw device interface provided by UNIX-type operating systems). Database and file systems 1 can be components of existing data storage systems or can be specially constructed to take full advantage of the methods of the present invention.

In another alternative, database system 3 utilizes the methods of the present invention for some of its storage accesses (across interfaces 15) and the standard methods of the operating system for others of its storage accesses (across interfaces 16). Finally, in a further alternative (not illustrated), the methods of the present invention may directly interface with user-level data-dependent applications. Therefore, as generally illustrated, the methods of the present invention either replace the record storage components of existing data storage systems or serve as the foundation for the construction of new data storage systems.

Finally, the methods and structures of the present invention may be implemented in programs written in any convenient programming language, such as C or C++. To perform these methods and allocate these structures, these programs are loaded into loaded into (typically) processor-accessible main memory from secondary storage (or elsewhere in the storage hierarchy) in a suitably encoded form. Once in main memory, the coded instructions cause the processor to perform the methods and allocate the data structures of the present invention. In order to deliver these programs to a computer system, they may be loaded from any computer readable media 17 in any convenient manner into system storage. Computer readable media can include, inter alia, removable magnetic or optical disks, alternately they can be loaded over a network connection.

The exemplary computer systems and software structures of FIGS. 1A-C are not to be taken as limiting. One of skill in the art, in view of the following description, will recognize them as examples of the types of structures for implementing this invention and of the types systems in which this invention is immediately applicable. For example, with respect to FIG. 1A, an alternative with increased parallelism could include more than one independent controller for the disk devices, each controller having a separate independent I/O bus to main memory. With respect to FIG. 1C, the methods of the present invention could be packaged as supplementary interface in the operating system, or be transparently bundled in a file system and/or in a database system. They could also function as separate processes to perform data server functions to local and/or distributed client tasks.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

A number of references are cited herein, the entire disclosures of which are incorporated herein, in their entirety, by reference for all purposes. Further, none of these references, regardless of how characterized above, is admitted as prior to the invention of the subject matter claimed herein.

What is claimed:

1. A method for storing a compressed database in memory comprising:
a. separating the compressed database into groups of columns;
b. storing one or more sorted representations of the groups of columns in a first memory, each representation is sorted by one or more criteria;
c. receiving user input;
d. selecting at least one of the one or more representations of groups of columns based on the received user input; and
e. storing in a second memory the selected at least one representation.

2. The method of claim 1, wherein the step of selecting is further based on previously received user input.

3. The method of claim 2, wherein the first memory is a hard disk.

4. The method of claim 3, wherein the second memory is a random access memory.

5. The method of claim 2, wherein user input is a database query comprising the one or more criteria.

6. The method of claim 5 further comprising updating a record of criteria of the previously received database query with criteria from the received database query.

7. The method of claim 6, wherein the step of selecting is based on the record of criteria.

8. The method of claim 1, wherein each group of columns comprises at least one column.
